(19) United States
(12) Patent Application Publication
(10) Pub. No.: US 2025/0207835 A1
(43) Pub. Date: Jun. 26, 2025

(54) REFRIGERATOR AND CONTROLLING METHOD FOR SAME

(71) Applicant: SAMSUNG ELECTRONICS CO., LTD., Suwon-si (KR)

(72) Inventors: Seulki MIN, Suwon-si (KR); Heemoon JEONG, Suwon-si (KR); Gaeul CHO, Suwon-si (KR); Kookjeong SEO, Suwon-si (KR); Insub LEE, Suwon-si (KR)

(73) Assignee: SAMSUNG ELECTRONICS CO., LTD., Suwon-si (KR)

(21) Appl. No.: 19/080,442

(22) Filed: Mar. 14, 2025

Related U.S. Application Data
(63) Continuation of application No. PCT/KR2023/011106, filed on Jul. 31, 2023.

(30) Foreign Application Priority Data
Oct. 12, 2022 (KR) 10-2022-0130971

(51) Int. Cl. F25B 49/02; F25B 41/20

(52) U.S. Cl. CPC F25B 49/022; F25B 41/20; F25B 2600/2511

(57) ABSTRACT

A refrigerator includes: a compressor; a condenser connected to the compressor; a first valve including a first input port, a first port and a second port, and a third port; a second valve including a second input port connected to the third port, a first output port, a second output port, and a third output port; and a controller configured to control the first valve to allow the first input port to communicate with the first port and to allow the second port to communicate with the third port in the first mode, control the first valve to close the second port and to allow the first port to communicate with the third port in the second mode, and control the first valve to close the first port and the second port and to allow the first input port to communicate with the third port in the third mode.

### CROSS REFERENCE TO THE RELATED APPLICATION

This application is a continuation application, filed under 35 U.S.C. § 111 (a), of International Application PCT/KR2023/011106 filed Jul. 31, 2023, and is based on and claims priority under 35 U.S.C. § 119 to Korean Patent Applications No. 10-2022-0130971, filed on Oct. 12, 2022 in the Korean Intellectual Property Office, the disclosures of which are incorporated by reference herein in their entireties.

### TECHNICAL FIELD

The disclosure relates to a refrigerator equipped with a cold air supplier, and a method for controlling the refrigerator.

### BACKGROUND ART

In general, a refrigerator employing a common cooling cycle by which a refrigerant is circulated therein is to keep various food items fresh for a long time by supplying cold air into food storage compartments, the cold air generated as the refrigerant in a liquid state absorbs surrounding heat while being evaporated. Among the food storage compartments, a freezing compartment is maintained at a temperature of approximately minus 20 degrees and a refrigerating compartment is maintained at a low temperature of approximately minus 3 degrees.

The refrigerant circulating through the refrigerator in the cooling cycle may have different cooling levels according to the surrounding temperature. For example, when the surrounding temperature is low, the refrigerant is supercooled and concentrated in the condenser, causing shortage of refrigerant on the evaporator side.

A way to overcome the shortage of refrigerant by increasing the number of revolutions of the compressor to increase pressure in the cooling cycle not only increases noise of the refrigerator but also increases the whole power consumption.

### DISCLOSURE

### Technical Problem

An aspect of the disclosure provides a refrigerator and a method for controlling the same that may prevent a shortage of refrigerant on an evaporator side.

An aspect of the disclosure provides a refrigerator and a method for controlling the same that may collect refrigerant left in a hot pipe.

An aspect of the disclosure provides a refrigerator and a method for controlling the same that may minimize a thermal load with a hot pipe to increase energy efficiency.

Technical objects that can be achieved by the disclosure are not limited to the above-mentioned objects, and other technical objects not mentioned will be clearly understood by one of ordinary skill in the art to which the disclosure belongs from the following description.

### Technical Solution

According to an aspect of the disclosure, a refrigerator may include: a compressor; a condenser connected to an outlet of the compressor; a hot pipe; a first capillary tube; a second capillary tube; a third capillary tube; a first valve including a first input port connected to an outlet of the condenser, a first port connected to one end of the hot pipe, a second port connected to another end of the hot pipe, and a third port; a second valve including a second input port connected to the third port, a first output port connected to the first capillary tube, a second output port connected to the second capillary tube, and a third output port connected to the third capillary tube; and a controller configured to operate the first valve in a first mode, a second mode or a third mode during an operation of the compressor, control the first valve to allow the first input port to communicate with the first port and to allow the second port to communicate with the third port in the first mode, control the first valve to close the second port and to allow the first port to communicate with the third port in the second mode, and control the first valve to close the first port and the second port and to allow the first input port to communicate with the third port in the third mode.

In addition, the controller may be configured to control the first valve to close the third port based on the compressor being turned off.

In addition, the refrigerator may further include: a first evaporator connected to the first capillary tube; a second evaporator connected to the second capillary tube; and a third evaporator connected to the third capillary tube.

In addition, the first evaporator may be connected to the third evaporator.

In addition, a refrigerant flowing into the first input port may pass through the hot pipe and be discharged to the second valve in the first mode, a refrigerant left in the hot pipe may be collected to (returned to) the second valve in the second mode, and a refrigerant flowing into the first input port may bypass the hot pipe and be discharged to the second valve in the third mode.

In addition, the controller may be configured to control the second valve based on an operation mode of the refrigerator.

In addition, the controller may be configured to: control the second valve to open the first output port based on the refrigerator being operating in a first cooling mode; control the second valve to open the second output port based on the refrigerator being operating in a second cooling mode; and control the second valve to open the third output port based on the refrigerator being operating in a third cooling mode.

In addition, the controller may be configured to control the second valve to open the first output port, the second output port and the third output port, based on the refrigerator being operating in a simultaneous cooling mode.

In addition, the controller may be configured to control the second valve to open the first output port and the second output port based on the refrigerator being operating in a fourth cooling mode; control the second valve to open the first output port and the third output port based on the refrigerator being operating in a fifth cooling mode; and control the second valve to open the second output port and the third output port based on the refrigerator being operating in a sixth cooling mode.

In addition, the first valve and the second valve may be configured to be controlled independently.

In addition, the first valve may include: an open cavity configured to selectively open one of the first port, the second port, and the third port; and a communication cavity configured to selectively communicate two ports among the first port, the second port, and the third port.

In addition, the second valve may be configured to selectively open the first output port, the second output port, and the third output port.

According to an aspect of the disclosure, in a method for controlling a refrigerator including a compressor; a condenser connected to an outlet of the compressor; a hot pipe; a first capillary tube; a second capillary tube; a third capillary tube; a first valve including a first input port connected to an outlet of the condenser, a first port connected to one end of the hot pipe, a second port connected to another end of the hot pipe, and a third port; and a second valve including a second input port connected to the third port, a first output port connected to the first capillary tube, a second output port connected to the second capillary tube, and a third output port connected to the third capillary tube, the method may include: operating the first valve in a first mode, a second mode or a third mode during an operation of the compressor; controlling the first valve to allow the first input port to communicate with the second port and to allow the first port to communicate with the third port in the first mode; controlling the first valve to close the second port and to allow the first port to communicate with the third port in the second mode; and controlling the first valve to close the first port and the second port and to allow the first input port to communicate with the third port in the third mode.

According to an aspect of the disclosure, a refrigerator may include: a compressor; a condenser connected to an outlet of the compressor; a hot pipe; a first capillary tube; a second capillary tube; a third capillary tube; a first valve including a first input port connected to an outlet of the condenser, a first port connected to one end of the hot pipe, a second port connected to another end of the hot pipe, a third port connected to the third capillary tube, and a fourth port; a second valve including a second input port connected to the fourth port, a first output port connected to the first capillary tube, and a second output port connected to the second capillary tube; and a controller configured to operate the first valve in a first mode, a second mode or a third mode during an operation of the compressor, control the first valve to allow one of the first port and the second port to communicate with the first input port and the other to communicate with the third port or the fourth port in the first mode, control the first valve to close one of the first port and the second port and to allow the other to communicate with the third port or the fourth port in the second mode, and control the first valve to close the first port and the second port and to allow the first input port to communicate with the third port or the fourth port in the third mode.

In addition, the controller may be configured to control the first valve to close the fourth port based on the compressor being turned off.

In addition, the refrigerator may further include: a first evaporator connected to the first capillary tube; a second evaporator connected to the second capillary tube; and a third evaporator connected to the third capillary tube.

In addition, the first evaporator may be connected to the third evaporator.

In addition, in the first mode, the controller may be configured to: based on the refrigerator being operating in a first cooling mode, control the first valve to allow the first input port to communicate with the second port and to allow the first port to communicate with the fourth port, and control the second valve to open the first output port; based on the refrigerator being operating in a second cooling mode, control the first valve to allow the first input port to communicate with the second port and to allow the first port to communicate with the fourth port and control the second valve to open the second output port; and based on the refrigerator being operating in a third cooling mode, control the first valve to allow the first input port to communicate with the first port and to allow the second port to communicate with the third port.

In addition, in the second mode, the controller may be configured to: based on the refrigerator being operating in a first cooling mode, control the first valve to allow the first input port to communicate with the fourth port, to close the second port, and to allow the first port to communicate with the third port, and control the second valve to open the first output port; based on the refrigerator being operating in a second cooling mode, control the first valve to allow the first input port to communicate with the fourth port, to close the second port, and to allow the first port to communicate with the third port, and control the second valve to open the second output port; and based on the refrigerator being operating in a third cooling mode, control the first valve to allow the first input port to communicate with the third port, to close the first port, and to allow the second port to communicate with the fourth port.

In addition, in the third mode, the controller may be configured to: based on the refrigerator being operating in a first cooling mode, control the first valve to allow the first input port to communicate with the fourth port and control the second valve to open the first output port; based on the refrigerator being operating in a second cooling mode, control the first valve to allow the first input port to communicate with the fourth port and control the second valve to open the second output port; and based on the refrigerator being operating in a third cooling mode, control the first valve to allow the first input port to communicate with the third port.

In addition, the first valve may include: an open cavity configured to selectively open one of the first port, the second port, the third port and the fourth port; and a communication cavity configured to selectively communicate two ports among the first port, the second port, the third port and the fourth port.

### Advantageous Effects

According to an aspect of the disclosure, a refrigerator may have increased energy efficiency.

According to an aspect of the disclosure, a shortage of refrigerant on an evaporator side may be prevented.

The effects that can be achieved by the disclosure are not limited to the above-mentioned effects, and other effects not mentioned will be clearly understood by one of ordinary skill in the technical art to which the disclosure belongs from the following description.

### DESCRIPTION OF DRAWINGS

FIG. 1 is a perspective view of a refrigerator according to an embodiment.

FIG. 2 illustrates an example of a cold air supplier including a valve device according to an embodiment.

FIG. 3A, FIG. 3B and FIG. 3C illustrate examples of a valve device including a first valve and a second valve according to an embodiment.

FIG. 4 is an exploded perspective view of a first valve according to an embodiment.

FIG. 5 illustrates a pad gear and a pad of a first valve being coupled to each other according to an embodiment.

FIG. 6 illustrates a pad of a first valve arranged on top of a boss according to an embodiment.

FIG. 7 illustrates a bottom surface of a boss of a first valve according to an embodiment.

FIG. 8 is a cross-sectional view of a pad of a first valve according to an embodiment.

FIG. 9 is a side cross-sectional view of a first valve according to an embodiment.

FIG. 10 is a schematic view for illustrating a flow of refrigerant through a valve device according to an embodiment.

FIG. 11 is a block diagram illustrating a configuration of a refrigerator according to an embodiment.

FIG. 12 illustrates a refrigerant flow through a valve device operating in a first mode in a case where a refrigerator operates in a first cooling mode and/or a second cooling mode according to an embodiment.

FIG. 13 illustrates a refrigerant flow through a valve device operating in a first mode in a case where a refrigerator operates in a third cooling mode according to an embodiment.

FIG. 14 illustrates a refrigerant flow through a valve device operating in a second mode in a case where a refrigerator operates in a first cooling mode and/or a second cooling mode according to an embodiment.

FIG. 15 illustrates a refrigerant flow through a valve device operating in a second mode in a case where a refrigerator operates in a third cooling mode according to an embodiment.

FIG. 16 illustrates a refrigerant flow through a valve device operating in a third mode in a case where a refrigerator operates in a first cooling mode and/or a second cooling mode according to an embodiment.

FIG. 17 illustrates a refrigerant flow through a valve device operating in a third mode in a case where a refrigerator operates in a third cooling mode according to an embodiment.

FIG. 18 illustrates a refrigerant flow through a valve device operating in a fourth mode.

FIG. 19A and FIG. 19B illustrate examples in which a valve device according to an embodiment includes a first valve and a second valve according to another embodiment.

FIG. 20 is a block diagram illustrating a configuration of a refrigerator according to an embodiment.

FIG. 21 illustrates a refrigerant flow through a valve device operating in a first mode.

FIG. 22 illustrates a refrigerant flow through a valve device operating in a second mode.

FIG. 23 illustrates a refrigerant flow through a valve device operating in a third mode.

FIG. 24 illustrates a refrigerant flow through a valve device operating in a fourth mode.

### MODES OF THE INVENTION

Embodiments and features as described and illustrated in the disclosure are merely examples, and there may be various modifications replacing the embodiments and drawings at the time of filing this application.

The terms used herein is for the purpose of describing particular embodiments only and is not intended to limit the disclosure.

For example, the singular forms used are intended to include the plural forms as well, unless the context clearly indicates otherwise.

The terms “comprises” and/or “comprising,” when used in this specification, represent the presence of stated features, integers, steps, operations, elements, components or combinations thereof, but do not preclude the presence or addition of one or more other features, integers, steps, operations, elements, components, or combinations thereof.

The term including an ordinal number such as “first”, “second”, or the like is used to distinguish one component from another and does not restrict the former component.

Furthermore, the terms, such as “˜portion”, “˜block”, “˜member”, “˜module”, etc., may refer to a unit of handling at least one function or operation. For example, the terms may refer to at least one process handled by hardware such as a field-programmable gate array (FPGA)/application specific integrated circuit (ASIC), etc., software stored in a memory, or at least one processor.

An embodiment of the disclosure will now be described in detail with reference to accompanying drawings. Throughout the drawings, like reference numerals or symbols refer to like parts or components.

Hereinafter, the operating principle and embodiments of the disclosure are described with reference to accompanying drawings.

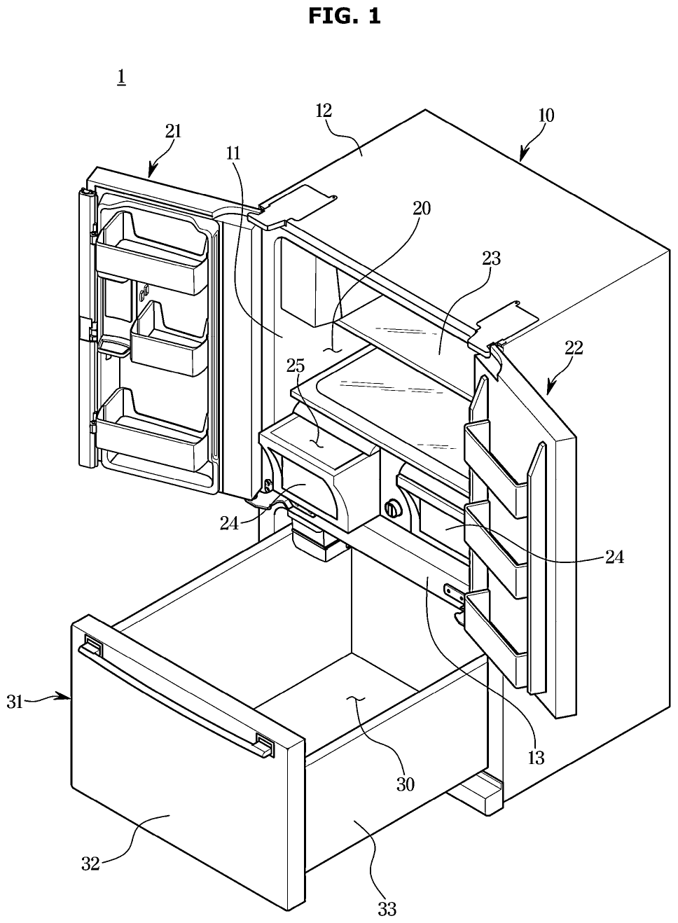

FIG. 1 is a perspective view of a refrigerator according to an embodiment.

Referring to FIG. 1, a refrigerator 1 according to an embodiment may include a main body 10, at least one storage compartment 20 and 30 formed in the main body 10, and at least one door 21, 22 and 31 arranged to open or close the at least one storage compartment 20 and 30.

The main body 10 may include an inner case 11 that defines the storage compartments 20 and 30, an outer case 12 coupled onto the outer side of the inner case 11, and insulation (not shown) arranged between the inner case 11 and the outer case 12.

The inner case 11 may be formed of a plastic substance through injection molding, and the outer case 12 may be formed of a metal substance. For the insulation, urethane foam insulation may be used, and when required, used with vacuum insulation.

After the inner case 11 and the outer case 12 are coupled with each other, the urethane foam insulation may be formed by filling foamed urethane obtained by mixing urethane and a foam agent in between the inner case 11 and the outer case 12. The foamed urethane is strongly adhesive, thus reinforcing coupling power between the inner case 11 and the outer case 12, and may have sufficient strength after foaming is complete.

The main body 10 may include a middle wall 13 that makes vertical division into the storage compartments 20 and 30. The middle wall 13 may separate the refrigerating compartment 20 from the freezing compartment 30.

However, the partitioning manner of the storage compartments 20 and 30 is not limited to what is shown in FIG. 1, but may be implemented in various known ways.

The storage compartments 20 and 30 may include the refrigerating compartment 20 formed in the upper portion of the main body 10 and the freezing compartment 30 formed in the lower portion of the main body 10. In other words, the freezing compartment 30 may be placed under the refrigerating compartment 20.

The refrigerating compartment 20 may be maintained at temperatures of about 0 to 5 degrees Celsius to keep foods refrigerated. The freezing compartment 30 may be maintained at temperatures of about minus 30 to 0 degree Celsius to keep foods frozen.

Shelves 23 for food items to be put thereon and a temperature conversion compartment 25 formed inside a temperature conversion compartment door 24 may be provided in the refrigerating compartment 20.

The temperature conversion compartment 25 is a separate storage compartment in which a target temperature varies according to the user settings, and food may be stored at a different temperature from the refrigerating compartment 20 and the freezing compartment 30.

According to various embodiments, the refrigerating compartment 20, the freezing compartment 30, and the temperature conversion compartment 25 may each be provided with different evaporators.

The refrigerating compartment 20 and the freezing compartment 30 may each have an open front to put in and take out foods. The open front of the refrigerating compartment 20 may be opened or closed by a pair of refrigerating compartment doors 21 and 22 coupled with the main body 10. The refrigerating compartment doors 21 and 22 may be rotationally coupled with the main body 10. The open front of the freezing compartment 30 may be opened or closed by a freezing compartment door 31 that may slide against the main body 10. The freezing compartment door 31 may be shaped like a box with an open top side, and may include a front plate 32 defining an exterior and a drawer 33 coupled to the rear side of the front plate 32.

However, the shape of the freezing compartment door 31 is not limited thereto, and the freezing compartment door 31 may have a shape that is rotationally coupled with the main body 10 like the refrigerating compartment doors 21 and 22.

Gaskets (not shown) may be arranged on rear edges of the refrigerating compartment doors 21 and 22 to seal up the space between the refrigerating compartment doors 21 and 22 and the main body 10 to contain cold air of the refrigerating compartment 20 when the refrigerating compartment doors 21 and 22 are closed.

The temperature conversion compartment 25 may have an open upper side to allow food to be taken in and out.

The temperature conversion compartment door 24 may be formed as a sliding drawer. However, the shape of the temperature conversion compartment 25 and the shape of the temperature conversion compartment door 24 are not limited thereto, and any type of the temperature conversion compartment door 24 may be used as long as it may control cold air independently of the refrigerating compartment 20 and the freezing compartment 30 when the temperature conversion compartment door 24 is closed.

In addition, the refrigerator 1 may include a cold air supplier 100 for supplying cold air into the storage compartments. The cold air supplier 100 will be described in detail below.

In addition, the shape of the refrigerator 1 may not be limited to what is described above, but may have various forms, such as a top-mounted freezer (TMF) refrigerator with the freezing compartment formed in the upper portion of the main body 10 and the refrigerating compartment formed in the lower portion of the main body 10, or a side-by-side (SBS) refrigerator.

Furthermore, any type of refrigerator 1 may be used as long as it receives cold air from the cold air supplier 100.

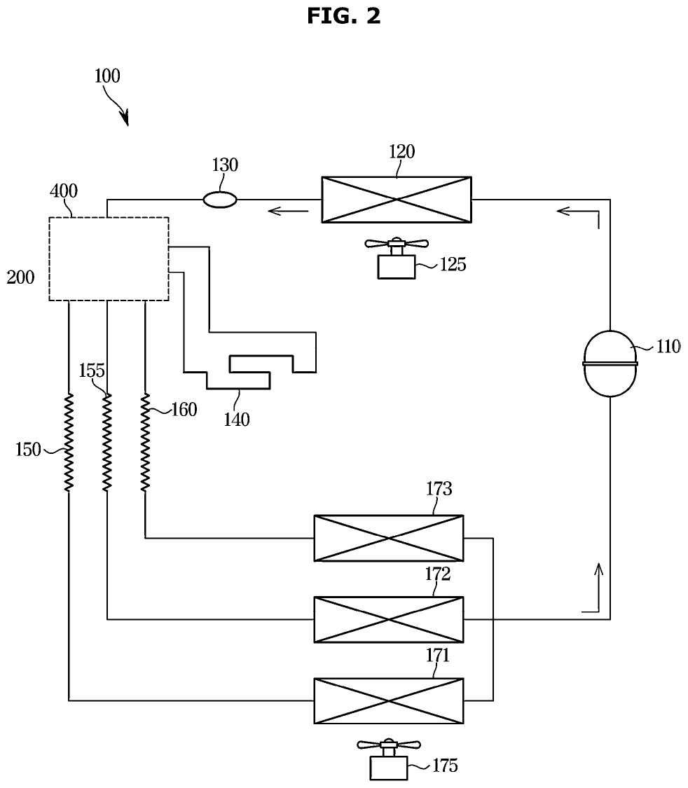

FIG. 2 illustrates an example of a cold air supplier including a valve device according to an embodiment.

Referring to FIG. 2, the cold air supplier 100 may include a compressor 110 and a condenser 120.

The compressor 110 may compress a refrigerant provided to circulate through the cold air supplier 100 to high-temperature and high-pressure gas.

The condenser 120 may condense the refrigerant compressed by the compressor 110. Specifically, the condenser 120 may be connected to an outlet of the compressor 110 for radiating heat from the high-temperature high-pressure gaseous refrigerant compressed by the compressor 110 to make a phase change to a room temperature liquid.

The cold air supplier 100 may further include a dryer 130. The dryer 130 may remove moisture contained in the refrigerant.

The working refrigerant flowing through the cold air supplier 100 may include HC based isobutane (R600a), propane (R290), HFC-based R134a, or HFO-based R1234yf. The type of the refrigerant is not limited thereto, but any refrigerant that attains a target temperature through heat exchange with surroundings may be used.

An outlet of the condenser 120 may be connected to a valve device 400 directly or via the dryer 130.

The cold air supplier 100 may include a hot pipe 140.

The hot pipe 140 may be arranged where the main body 10 of the refrigerator 1 meets the doors 21, 22 and 31 and installed around the main body 10 to prevent condensation of water vapor.

The hot pipe 140 may be a pipe installed to prevent dew formation caused in a gasket portion of the doors 21, 22 and 31, which are vulnerable to the temperature in the refrigerator 1. Accordingly, dew formation around the doors 21, 22 and 31 may be prevented when the hot refrigerant flows in the hot pipe 140.

Both ends of the hot pipe 140 may be connected to the valve device 400.

The cold air supplier 100 may include at least one capillary tube 150, 155, and 160.

For example, the cold air supplier 100 may include the first capillary tube 150, the second capillary tube 155, and the third capillary tube 160.

Then number of capillary tubes is not limited thereto, and may vary depending on the type of the refrigerator 1 or as required.

The first capillary tube 150, the second capillary tube 155, and the third capillary tube 160 may have different diameters and lengths.

The refrigerant may expand and be decompressed while flowing through the at least one capillary tube 150, 155, and 160.

For example, the refrigerant may expand and be decompressed while flowing through the first capillary tube 150, the second capillary tube 155, and/or the third capillary tube 160.

One end of the at least one capillary tube 150, 155, and 160 may be connected to the valve device 400, and the other end may be connected to at least one evaporator 171, 172, and 173.

The cold air supplier 100 may include the at least one evaporator 171, 172, and 173.

For example, the cold air supplier 100 may include the first evaporator 171 connected to the first capillary tube 150, the second evaporator 172 connected to the second capillary tube 155, and the third evaporator 173 connected to the third capillary tube 160.

According to various embodiments, the first evaporator 171 may be arranged in the temperature conversion compartment 25, the second evaporator 172 may be arranged in the refrigerating compartment 20, and the third evaporator 173 may be arranged in the freezing compartment 30. The first evaporator 171 may supply cold air into the temperature conversion compartment 25, the second evaporator 172 may supply cold air into the refrigerating compartment 20, and the third evaporator 173 may supply cold air into the freezing compartment 30.

However, the locations of the first evaporator 171, the second evaporator 172, and the third evaporator 173 are not limited thereto.

For example, the first evaporator 171 may be provided in one of the refrigerating compartment 20, the temperature conversion compartment 25, and the freezing compartment 30, the second evaporator 172 may be provided in another one of the refrigerating compartment 20, the temperature conversion compartment 25, and the freezing compartment 30, and the third evaporator 173 may be provided in the remaining one of the refrigerating compartment 20, the temperature conversion compartment 25, and the freezing compartment 30.

The diameter and length of each of the first capillary tube 150, the second capillary tube 155, and the third capillary tube 160 may be designed in advance according to the positions of the first evaporator 171, the second evaporator 172, and the third evaporator 173.

Hereinafter, for convenience of description, it is assumed that the first evaporator 171 is installed in the temperature conversion compartment 25, the second evaporator 172 is installed in the refrigerating compartment 20, and the third evaporator 173 is installed in the freezing compartment 30.

The refrigerator 1 according to an embodiment may operate in various cooling modes.

For example, the refrigerator 1 may operate in a variable temperature mode, a refrigeration mode, a freezing mode, a simultaneous cooling mode, or the like, based on the temperature in the storage compartment 20, 25 and 30.

In a case where the refrigerator 1 operates in the variable temperature mode, the refrigerant may flow to the first evaporator 171.

In a case where the refrigerator 1 operates in the refrigeration mode, the refrigerant may flow to the second evaporator 172.

In a case where the refrigerator 1 operates in the freezing mode, the refrigerant may flow to the third evaporator 173.

According to various embodiments, in a case where the refrigerator 1 operates in the simultaneous cooling mode, the refrigerant may flow to the first evaporator 171, the second evaporator 172, and the third evaporator 173.

The cold air supplier 100 may include a heat radiation fan 125 and an air blow fan 175.

The heat radiation fan 125 may be arranged near the condenser 120. The air blow fan 175 may be arranged near each of the evaporators 171, 172 and 173.

Although a single air blow fan 175 is shown in the drawings, the air blow fan 175 may include a first blower fan arranged adjacent to the first evaporator 171, a second blower fan arranged adjacent to the second evaporator 172, and/or a third blower fan arranged adjacent to the third evaporator 173.

The heat radiation fan 125 may increase heat radiation efficiency of the condenser 120. The air blow fan 175 may be provided to increase evaporation efficiency of the evaporators 171, 172, and 173.

The cold air supplier 100 may include the valve device 400.

The valve device 400 may include a plurality of ports connected to the respective components of the cold air supplier 100.

In an embodiment, the valve device 400 may include a port connected to the outlet of the condenser 120, a port connected to an end of the hot pipe 140, a port connected to the other end of the hot pipe 140, a third port connected to the first capillary tube 150, a port connected to the second capillary tube 155, and a port connected to the third capillary tube 160.

As will be described below, the valve device 400 may include at least one valve. For example, the valve device 400 may include a single 6-way valve, two 4-way valves, a single 5-way valve and a single 3-way valve. However, the type and number of valves included in the valve device 400 are not limited thereto.

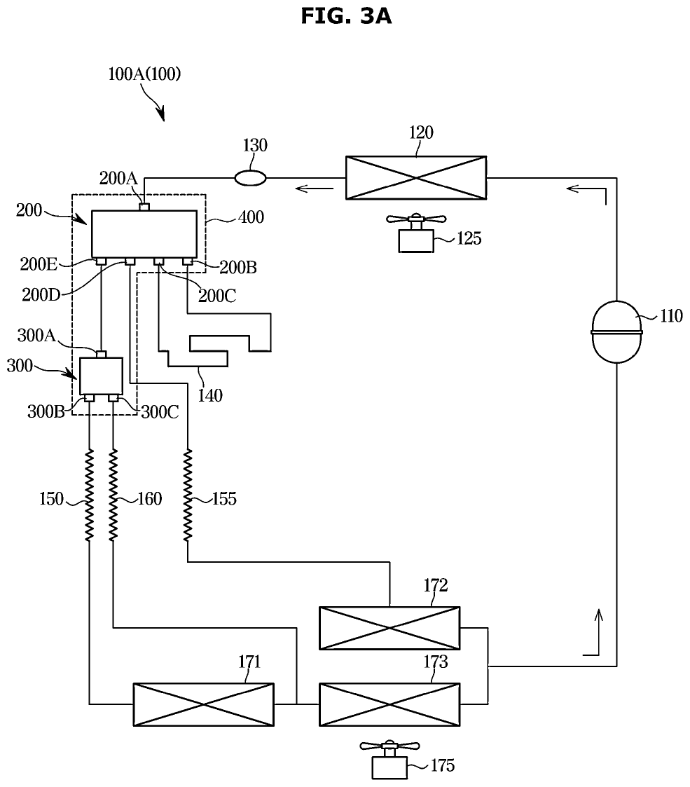

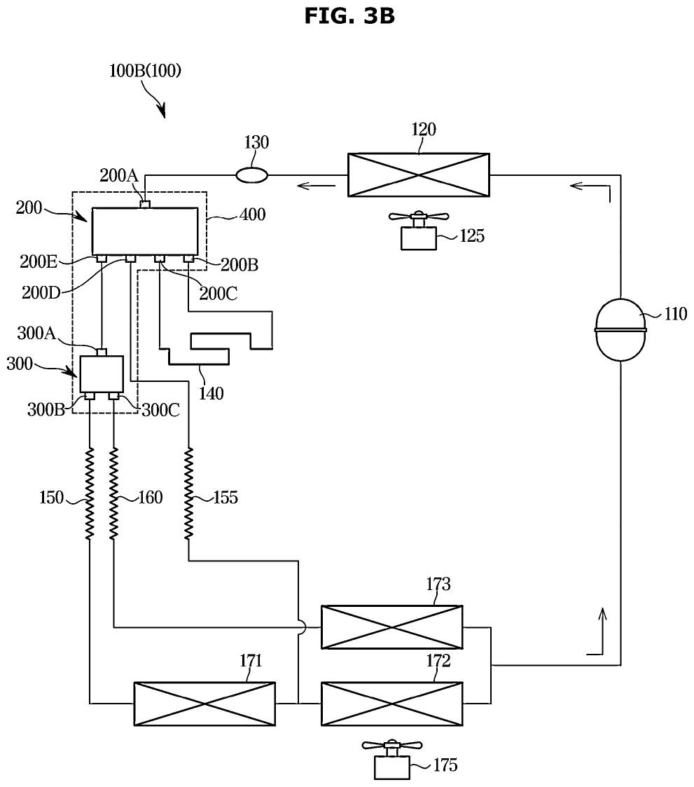

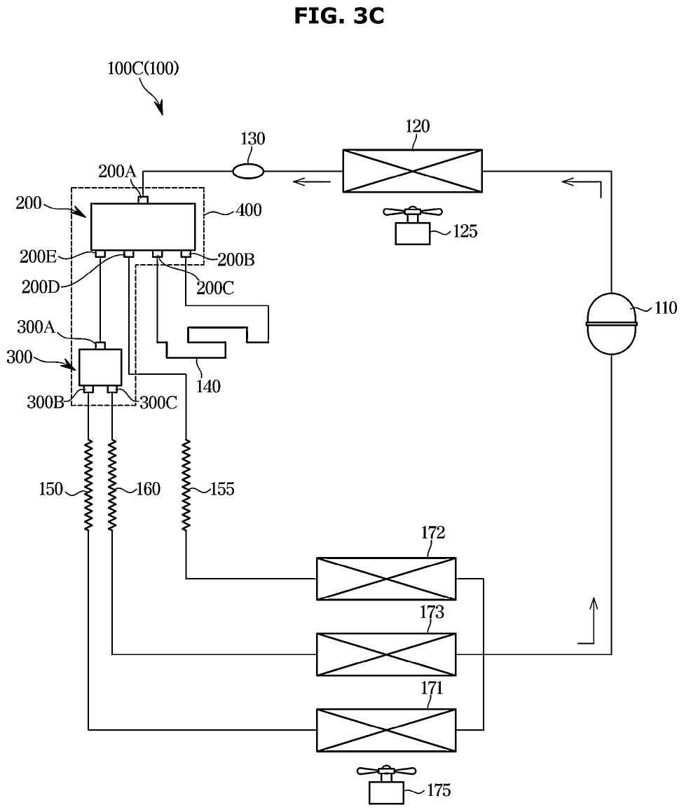

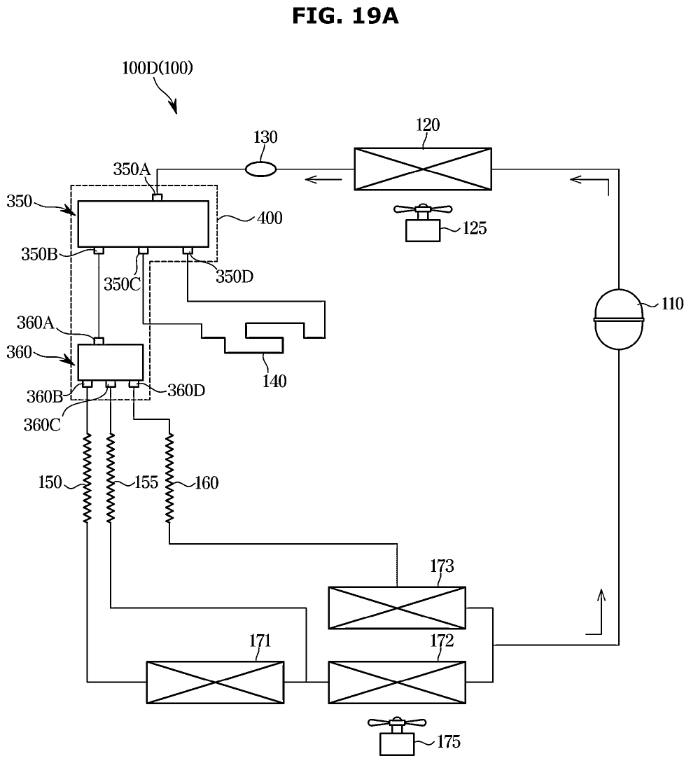

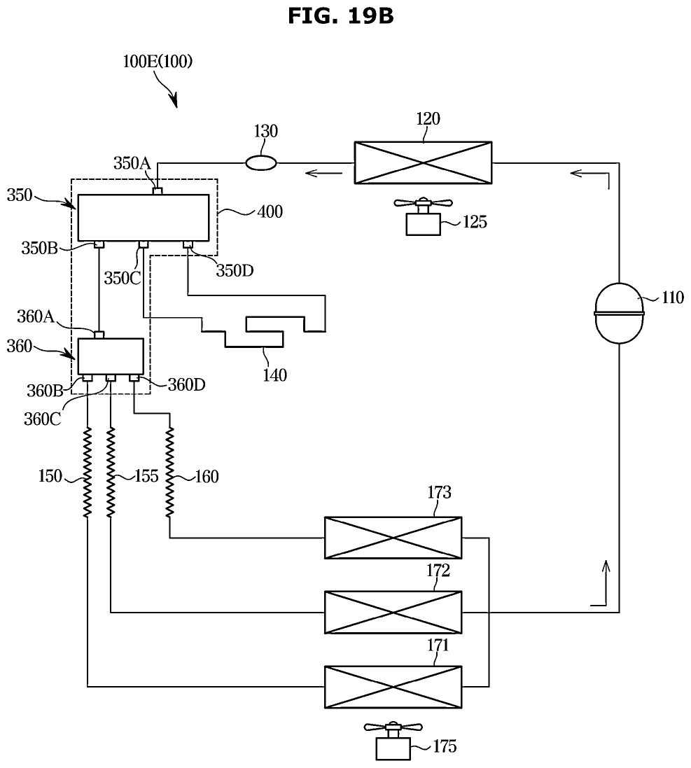

FIG. 3A, FIG. 3B and FIG. 3C illustrate embodiments of the valve device 400 including a single 5-way valve and a single 3-way valve. FIG. 19A and FIG. 19B illustrate embodiments of the valve device 400 including two 4-way valves.

Hereinafter, the valve device 400 and the refrigerant flow according to an operation of the valve device 400 according to various embodiments are described with reference to each drawing.

FIG. 3A, FIG. 3B and FIG. 3C illustrate examples of a valve device including a first valve and a second valve according to an embodiment.

Referring to FIG. 3A, FIG. 3B and FIG. 3C, the cold air suppliers 100A, 100B, and 100C according to an embodiment may each include the valve device 400 including a first valve 200 and a second valve 300.

In addition, the cold air supplier 100A according to an embodiment may include the first capillary tube 150 connected to the first evaporator 171, the second capillary tube 155 connected to the second evaporator 172, and the third capillary tube 160 connected to the third evaporator 173.

Referring to FIG. 3A, according to various embodiments, one end of the first evaporator 171 may be connected to the first capillary tube 150, and the other end may be connected to the third evaporator 173. One end of the second evaporator 172 may be connected to the second capillary tube 155, and the other end may be connected to the compressor 110. One end of the third evaporator 173 may be connected to the third capillary tube 160 and the first evaporator 171, and the other end may be connected to the compressor 110.

Referring to FIG. 3B, according to various embodiments, one end of the first evaporator 171 may be connected to the first capillary tube 150, and the other end may be connected to the second evaporator 172. One end of the second evaporator 172 may be connected to the second capillary tube 155 and the first evaporator 171, and the other end may be connected to the compressor 110. One end of the third evaporator 173 may be connected to the third capillary tube 160, and the other end may be connected to the compressor 110.

Referring to FIG. 3C, according to various embodiments, one end of the first evaporator 171 may be connected to the first capillary tube 150, and the other end may be connected to the compressor 110. One end of the second evaporator 172 may be connected to the second capillary tube 155, and the other end may be connected to the compressor 110. One end of the third evaporator 173 may be connected to the third capillary tube 160, and the other end may be connected to the compressor 110.

However, the arrangement of the first evaporator 171, the second evaporator 172, and the third evaporator 173 may be changed in various ways as required.

The first valve 200 may be implemented as a 5-way valve having five ports.

The first valve 200 may include a port 200A connected to the outlet of the condenser 120, a port 200B connected to one end of the hot pipe 140, a port 200C connected to the other end of the hot pipe 140, a port 200D connected to the second capillary tube 155, and a port 200E connected to the second valve 300.

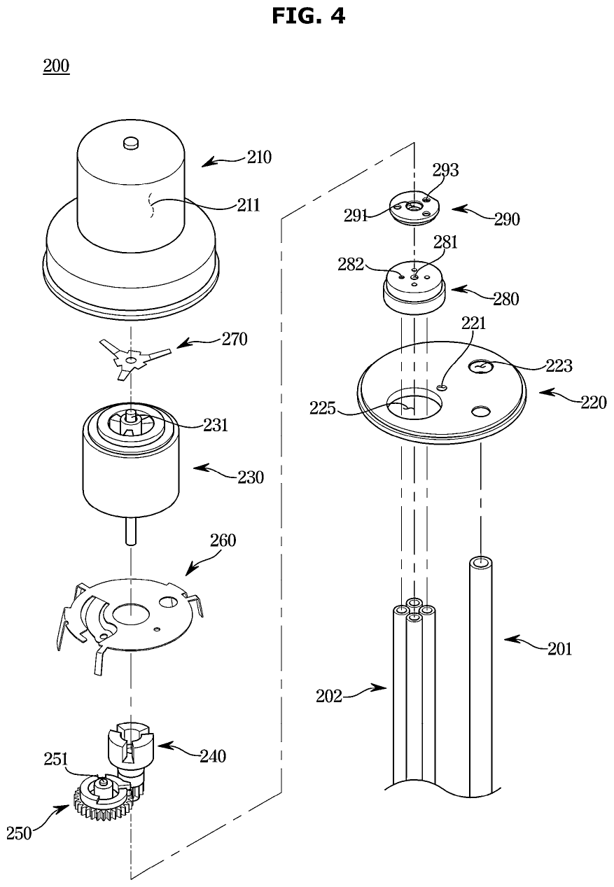

The structure of the first valve 200 is described below with reference to FIG. 4 to FIG. 9.

The second valve 300 may be implemented as a 3-way valve having three ports.

The second valve 300 may include a port 300A connected to the first valve 200, a port 300B connected to the first capillary tube 150, and a port 300C connected to the third capillary tube 160.

The compressor 110, the condenser 120, the dryer 130, the hot pipe 140, the valve device 400, the plurality of capillary tubes 150, 155 and 160, and the plurality of evaporators 171, 172 and 173 described above may be connected through connection tubes, and thus a closed loop refrigerant circuit in which refrigerant circulates may be formed in the refrigerator 1.

As the compressor 110 operates, the refrigerant may circulate in the direction of the compressor 110, the condenser 120, and the evaporators 171, 172, and 173.

According to various embodiments, the cold air supplier 100 may further include additional components, and some components (e.g., the dryer 130) may be omitted.

Hereinafter, the first valve constituting the valve device 400 shown in FIG. 3A, FIG. 3B, and FIG. 3C is described with reference to FIG. 4 to FIG. 9.

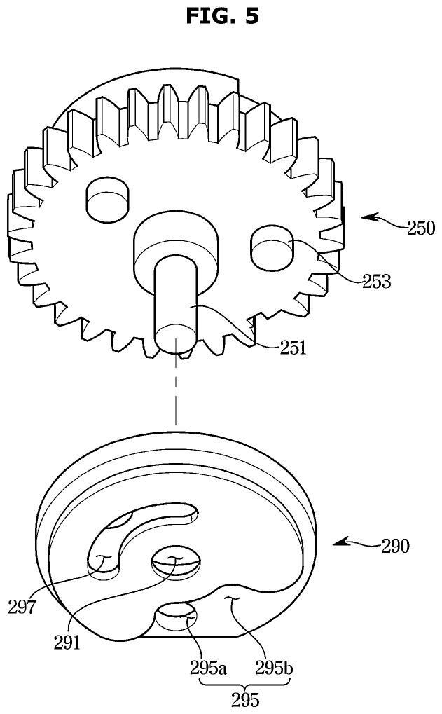

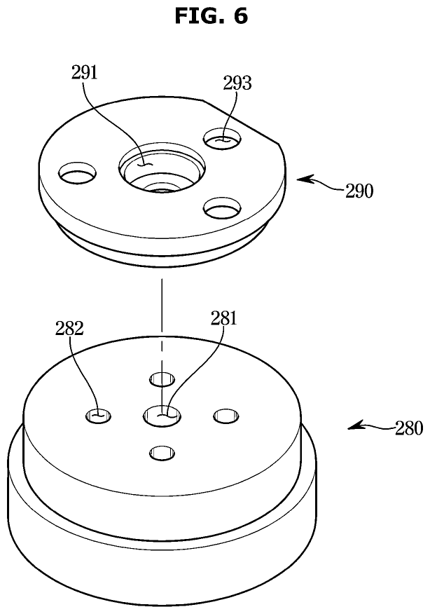

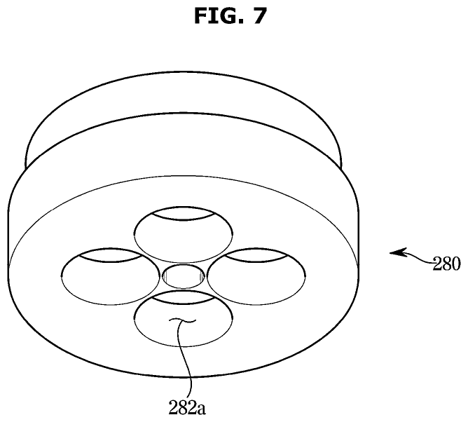

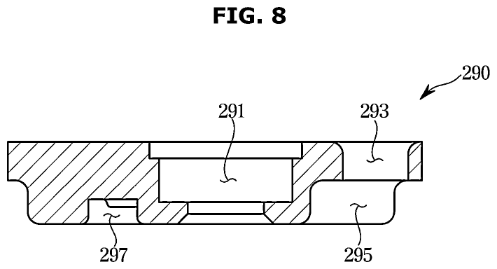

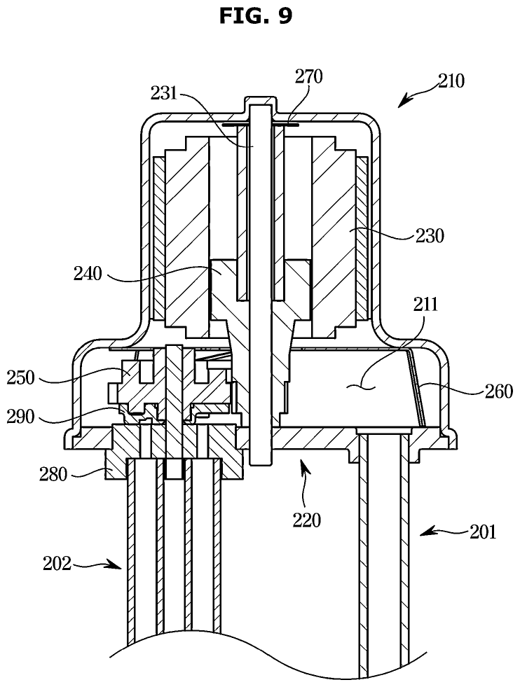

FIG. 4 is an exploded perspective view of a first valve according to an embodiment. FIG. 5 illustrates a pad gear and a pad of a first valve being coupled to each other according to an embodiment. FIG. 6 illustrates a pad of a first valve arranged on top of a boss according to an embodiment. FIG. 7 illustrates a bottom surface of a boss of a first valve according to an embodiment. FIG. 8 is a cross-sectional view of a pad of a first valve according to an embodiment. FIG. 9 is a side cross-sectional view of a first valve according to an embodiment.

In an embodiment, the value device 400 may include the first valve 200 and the second valve 300. As described above, the first valve 200 may be a 5-way valve having five ports.

Referring to FIG. 4 to FIG. 9, the first valve 200 may include a case 210, a base plate 220 covering an open bottom of the case 210, a flow-in pipe 201 into which the refrigerant flows, a plurality of flow-in/out pipes 202 through which the refrigerant flows in/out, a boss 280, and a pad 290 rotationally arranged on the boss 280. Here, the boss 280 may include a port (281; 202A) through which refrigerant is introduced through the flow-in pipe 201, and a plurality of ports (282; 200B, 200C, 200D, 200E) through which refrigerant flows in and out through the plurality of flow-in/out pipes 202.

The case 210 may be provided to have an open bottom and a receiving space 211 formed therein.

A rotor 230 may be arranged in the receiving space 211 in the case 210. The rotor 230 may include a rotor shaft 231.

In addition, a pinion gear 240 may be arranged in the receiving space 211. The pinion gear 240 may be coupled to the rotor 230. The pinion gear 240 may be coupled to the rotor shaft 231 and rotated along with the rotor 230.

In addition, a pad gear 250 may be arranged in the receiving space 211. The pad gear 250 may be arranged on a side of the pinion gear 240. The pad gear 250 may be in gear with the pinion gear 240 and engaged with the pinion gear 240. Accordingly, when the pinion gear 240 is rotated by the rotor 230, the pad gear 250 may be rotated by the pinion gear 240. The pad gear 250 may include a pad valve shaft 251 corresponding to a rotation axis. The pad valve shaft 251 may be coupled to the pad 290 to allow the pad 290 to rotate along with the pad gear 250. The pad gear 250 may include a pad coupling projection 253 coupled to the pad 290. The pad coupling projection 253 may be provided in the plural. The pad coupling projection 253 may be provided on the bottom side of the pad gear 250. The pad coupling projection 253 may be coupled to a pad gear coupling hole 293 formed at the top side of the pad 290.

In addition, an elastic support spring 260 may be arranged in the receiving space 211. The elastic support spring 260 may be fixed to the case 210 in the receiving space 211. The elastic support spring 260 may be in a plate type. The elastic support spring 260 may elastically support a top center of the pad gear 250. The pad gear 250 may be rotationally mounted at the elastic support spring 260.

In addition, a rotor support plate spring 270 may be arranged in the receiving space 211. The rotor support plate spring 270 may be fixed to the case 210 in the receiving space 211. The rotor support plate spring 270 may elastically support the rotor 230. The rotor 230 may be rotationally supported on the rotor support late spring 270.

The base plate 220 may cover the open bottom of the case 210. The base plate 220 may include a rotor shaft support hole 221 through which the rotor shaft 231 is rotationally supported. The base plate 220 may include the input port 200A coupled to the flow-in pipe 201 to which the refrigerant flows in. The base plate 220 may include a boss hole 225 through which the boss 280 is installed.

The boss 280 may be installed in the boss hole 225 of the base plate 220. An upper portion of the boss 280 may be arranged in the receiving space 211. A lower portion of the boss 280 may be arranged outside the receiving space 211. The boss 280 may include the pad valve shaft hole 281 to which the pad valve shaft 251 is rotationally inserted. The boss 280 may include the plurality of ports 282 through which the refrigerant flows in and out. The plurality of ports 282 may be connected to the plurality of flow-in/out pipes 202 through which the refrigerant flows in and out. There may be four ports 282. Also, there may be four flow-in/out pipes 202 coupled to the plurality of ports 282. The boss 280 may include a plurality of insertion holes 282a to which the plurality of flow-in/out pipes 202 are inserted. There may be four insertion holes 282a to match the number of the plurality of flow-in/out pipes 202. The plurality of insertion holes 282a may be connected to the plurality of ports 282.

The pad 290 may be rotationally arranged on top of the boss 280. The pad 290 may include a pad valve shaft coupling hole 291 to which the pad valve shaft 251 is coupled. The pad 290 may include a pad gear coupling hole 293 to which the pad coupling projection 253 of the pad gear 250 is coupled. Accordingly, the pad 290 may be rotated along with the pad gear 250.

The pad 290 may include an open cavity 295 that selectively opens one of the plurality of ports 282 formed in the boss 280. The open cavity 295 may be formed in a lower portion of the pad 290. The open cavity 295 may have the form of a groove sunken upward from the bottom surface of the pad 290. The open cavity 295 may be formed to extend to an edge of the pad 290 in a radial direction. The open cavity 295 may have a size of 75 to 80 degrees in a circumferential direction of the pad 290 with respect to the center of the pad 290. The open cavity 295 may include a first area 295a formed on one side of the open cavity 295 and a second area 295b formed on the other side of the open cavity 295. The first area 295a may be located near the leftmost end of the pad 290 when the pad 290 is viewed from above (see FIG. 8). The second area 295b may be located near the rightmost end of the pad 290 when the pad 290 is viewed from above. The second area 295b may be at a location rotated 45 degrees from the first area 295a with respect to the center of the pad 290. The open cavity 295 may have a size to selectively open one (200B, 200C, 200D or 200E) of the plurality of ports 282 in the first area 295a or the second area 295b. The open cavity 295 may have a size that is unable to open two of the plurality of ports 282 at a time. In other words, one of the plurality of ports 282 may be opened in the first area 295a or in the second area 295b. The pad 290 may be rotated along with the pad gear 250 to selectively open one (200B, 200C, 200D or 200E) of the plurality of ports 282 formed in the boss 280.

The pad 290 may include a communication cavity 297 that selectively communicates two (200B, 200C, 200D, 200E) of the plurality of ports 282 formed in the boss 280. The communication cavity 297 may be formed in a lower portion of the pad 290. The communication cavity 297 may have the form of a groove sunken upward from the bottom surface of the pad 290. The communication cavity 297 may communicate two adjacent ports (200B and 200C, 200C and 200D, 200D and 200E, 200E and 200B) among the plurality of ports 282.

The first valve 200 may further include a stator (not shown). The stator may enclose a portion in which the rotor 230 is arranged, from outside of the case 210.

The first valve 200 may further include a bracket (not shown). The bracket may allow the case 210 to be coupled to the stator. The bracket may allow the first valve 200 to be fixed to an external device.

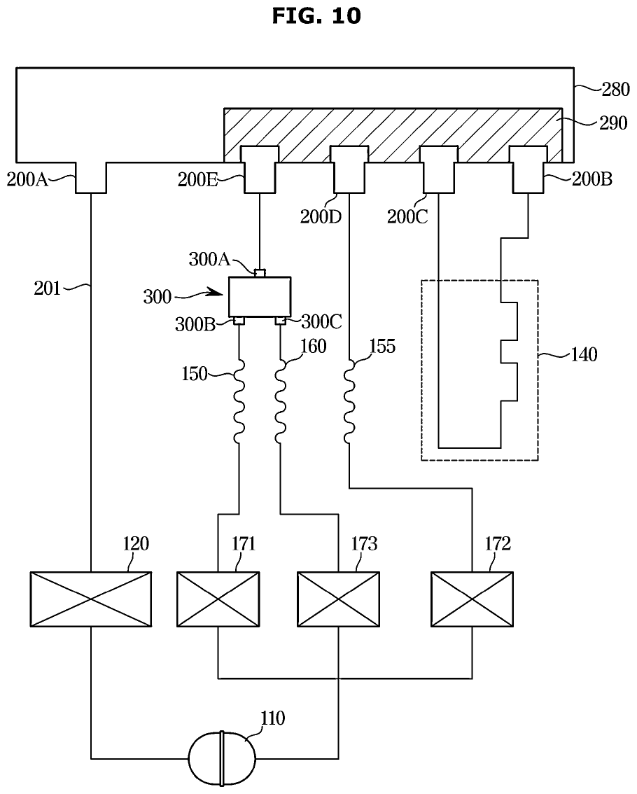

FIG. 10 is a schematic view for illustrating a flow of refrigerant through a valve device according to an embodiment.

Referring to FIG. 10, the valve device 400 according to an embodiment may include the first valve 200 and the second valve 300.

The first valve 200 may include the input port 200A connected to the outlet of the condenser 120, the port 200B connected to an end of the hot pipe 140, the port 200C connected to the other end of the hot pipe 140, the port 200D connected to the capillary tube 155, and the port 200E connected to an input port 300A of the second valve 300.

The second valve 300 may include the input port 300A connected to one port 200E of the plurality of ports 282 of the first valve 200, and two ports 300B and 300C connected to two capillary tubes 150 and 160.

As the compressor 110 operates, the refrigerant discharged from the outlet of the condenser 120 may be introduced into the first valve 200 through the flow-in pipe 201, and the refrigerant introduced into the first valve 200 may be discharged to the evaporator 172 or the second valve 300 through the open cavity 295 and the communication cavity 297, and the refrigerant introduced into the second valve 300 may be discharged to at least one evaporator 171 and 172.

As described above, the first valve 200 may selectively communicate two adjacent ports among the plurality of ports 200B, 200C, 200D, and 200E, and may communicate one of the plurality of ports 200B, 200C, 200D, and 200E with the input port 200A.

To this end, the pad 290 may include the open cavity 295 that selectively opens one port (200B, 200C, 200D or 200E) among the plurality of ports 200B, 200C, 200D, and 200E formed in the boss 280.

In addition, the pad 290 may include the communication cavity 297 that selectively communicates two ports among the plurality of ports 200B, 200C, 200D, and 200E formed in the boss 280.

The communication cavity 297 may communicate two ports among the plurality of ports 200B, 200C, 200D, and 200E.

The second valve 300 may discharge the refrigerant introduced into the input port 300A to at least one of the ports 300B and/or 300C.

That is, the second valve 300 may selectively open and close the port 300B connected to the first capillary tube 150, and selectively open and close the port 300C connected to the second capillary tube 160.

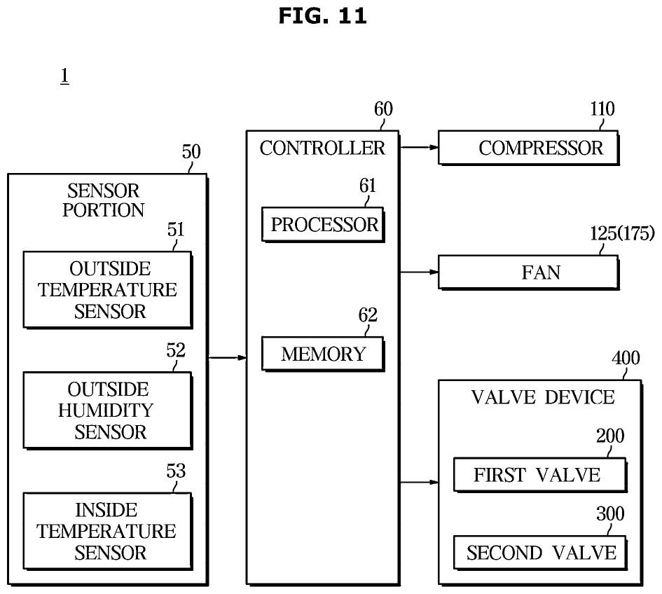

FIG. 11 is a block diagram illustrating a configuration of a refrigerator according to an embodiment.

Referring to FIG. 11, the refrigerator 1 according to an embodiment may include a sensor portion 50, the controller 60, and the cold air supplier 100.

The cold air supplier 100 may include the compressor 110, the fans 125 and 175, and the valve device 400.

In an embodiment, the valve device 400 may include the first valve 200 and the second valve 300. Descriptions of the compressor 110, the fans 125 and 175, and the valve device 400 are omitted to avoid duplication.

The sensor portion 50 may include an outside temperature sensor 51.

The outside temperature sensor 51 may detect air temperature outside the refrigerator 1, and transmit the outside temperature information to the controller 60. To this end, the outside temperature sensor 51 may be arranged in the main body 10.

The sensor portion 50 may include an outside humidity sensor 52.

The outside humidity sensor 52 may detect air humidity outside the refrigerant 1 and transmit the outside humidity information to the controller 60. To this end, the outside humidity sensor 52 may be arranged in the main body 10. The sensor portion 50 may include an inside temperature sensor 53.

The inside temperature sensor 53 may be arranged in the at least one storage compartment 20, 25 and 30 to detect temperature in the at least one storage compartment 20, 25 and 30. The inside temperature sensor 53 may send inside temperature information to the controller 60.

According to various embodiments, the inside temperature sensor 53 may include the first inside temperature sensor 53 provided in the temperature conversion compartment 25, the second inside temperature sensor 53 provided in the refrigerating compartment 20, and the third inside temperature sensor 53 provided in the freezing compartment 30. The first inside temperature sensor 53 may transmit temperature information of the temperature conversion compartment 25 to the controller 60, the second inside temperature sensor 53 may transmit temperature information of the refrigerating compartment 20 to the controller 60, and the third inside temperature sensor 53 may transmit temperature information of the freezing compartment 30 to the controller 60.

According to various embodiments, among the components of the sensor portion 50, the outside temperature sensor 51 and/or the outside humidity sensor 52 may be omitted. According to various embodiments, the outside temperature sensor 51 and the outside humidity sensor 52 may be implemented as a single sensor. According to various embodiments, the sensor portion 50 may further include an inside humidity sensor. For example, the inside humidity sensor may be implemented as the inside temperature sensor 53.

In an embodiment, the controller 60 may estimate outside temperature based on operation information of the compressor 110 and the inside temperature information.

For example, the controller 60 may estimate the outside temperature based on an operation time of the compressor 110 required to reduce the inside temperature by a predetermined value.

Although not shown, the refrigerator 1 may further include a communication module. Functions of the outside temperature sensor 51 and the outside humidity sensor 52 may be replaced by the communication module.

The communication module may transmit or receive data to or from an external device. For example, the communication module may transmit or receive various data by communicating with a server and/or a user terminal and/or a home appliance.

To this end, the communication module may support establishment of a direct (e.g., wired) communication channel or a wireless communication channel between external devices (e.g., a server, a user terminal and/or a home appliance), and communication through the established communication channel. According to an embodiment, the communication module may include a wireless communication module (e.g., a cellular communication module, a short-range wireless communication module or a global navigation satellite system (GNSS) communication module) or a wired communication module (e.g., a local area network (LAN) communication module or a power-line communication module). A corresponding one of the communication modules may communicate with an external electronic device over a first network (e.g., a short-range communication network such as Bluetooth, wireless-fidelity (Wi-Fi) direct or infrared data association (IrDA)) or a second network (e.g., a remote communication network such as a legacy cellular network, a fifth generation (5G) network, a next generation communication network, the Internet, or a computer network (e.g., a LAN or wide area network (WAN)). These various types of communication modules may be integrated into a single component (e.g., a single chip) or implemented as a plurality of separate components (e.g., a plurality of chips).

The communication module may include a Wi-Fi module, and perform communication with an external server and/or a user terminal and/or a home appliance based on establishment of communication with a home access point (AP).

The communication module may communicate with a home appliance at home to receive outside temperature information and outside humidity information from the home appliance.

For example, the communication module may communicate with an air conditioner at home to receive outside temperature information and outside humidity information from the air conditioner.

The controller 60 may include a processor 61 for generating a control signal for an operation of the refrigerator 1, and a memory 62 for storing a program, an application, instructions and/or data for operation of the refrigerator 1. The processor 61 and the memory 62 may be implemented as separate semiconductor devices or in a single semiconductor device. The controller 60 may include a plurality of processors 61 and a plurality of memories 62. The controller 60 may be provided in various positions inside the refrigerator 1. For example, the controller 60 may be included in a printed circuit board arranged inside a control panel.

The processor 61 may include an operation circuit, a storage circuit, and a control circuit. The processor 61 may include one or multiple chips. Furthermore, the processor 61 may include one or multiple cores.

The memory 62 may store a program for controlling the cold air supplier and data required to control the cold air supplier.

The memory 62 may include a volatile memory, such as a static random access memory (S-RAM) or a dynamic RAM (D-RAM), and a non-volatile memory, such as a read only memory (ROM) or an erasable programmable ROM (EPROM). The memory 62 may include a memory device, or multiple memory devices.

The processor 61 may process data and/or a signal based on the program provided from the memory 62, and transmit a control signal to each component of the refrigerator 1 based on the processing result. For example, the processor 61 may process information obtained from the sensor portion 50 (e.g., outside humidity information, outside temperature information, inside temperature information) and/or operation information of components included in the cold air supplier (e.g., mode information of the valve device 400, operation information of the compressor 110).

The components of the cold air supplier 100 (e.g., the compressor 110, the valve device 400, and the fans 125 and 175) may be controlled by the controller 60.

The first valve 200 and the second valve 300 may be controlled independently of each other.

The controller 60 may independently control the first valve 200 and the second valve 300.

The controller 60 may control the compressor 110, the fans 125 and 175, and/or the valve device 400 based on information collected by the sensor portion 50 and setting information stored in the memory 62.

According to various embodiments, the controller 60 may operate the valve device 400 in a first mode, a second mode, or a third mode while the compressor 110 is operating.

In addition, the controller 60 may operate the valve device 400 in a fourth mode based on the compressor 110 being turned off.

The first to fourth modes are modes classified based on refrigerant flow.

In the first mode, the refrigerant discharged from the condenser 120 may be discharged to the at least one evaporator 171, 172, and 173 via the hot pipe 140.

Accordingly, the first mode may be defined as a hot pipe-pass mode.

In the second mode, the refrigerant in the hot pipe 140 may be discharged to the at least one evaporator 171, 172, and 173.

Accordingly, the second mode may be defined as a refrigerant collection mode.

In the third mode, the refrigerant discharged from the condenser 120 may bypass the hot pipe 140 and may be discharged directly to the at least one evaporator 171, 172, and 173.

Accordingly, the third mode may be defined as a hot pipe-bypass mode.

In the fourth mode, the refrigerant discharged from the condenser 120 may not be discharged to the at least one evaporator 171, 172, and 173.

Accordingly, the fourth mode may be defined as a stop mode.

In addition, the refrigerator 1 may operate in a plurality of cooling modes which are distinguished according to the location where cold air is supplied.

The plurality of cooling modes may correspond to operation modes of the refrigerator 1, and may be classified according to a storage compartment in which an evaporator through which the refrigerant flows is located.

For example, the first cooling mode may refer to a mode in which the refrigerant is supplied to the first evaporator 171. In addition, the second cooling mode may refer to a mode in which the refrigerant is supplied to the second evaporator 172. In addition, the third cooling mode may refer to a mode in which the refrigerant is supplied to the third evaporator 173. In addition, the simultaneous cooling mode may refer to a mode in which the refrigerant is supplied to the first evaporator 171 and the third evaporator 173.

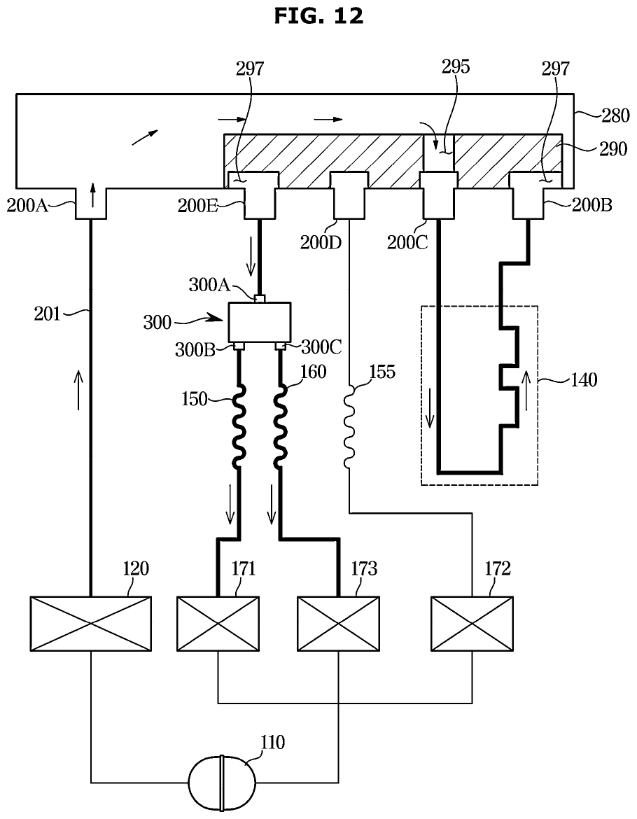

Hereinafter, the refrigerant flows according to the operation mode of the refrigerator and the operation mode of the valve device 400 are described with reference to FIG. 12 to FIG. 18.

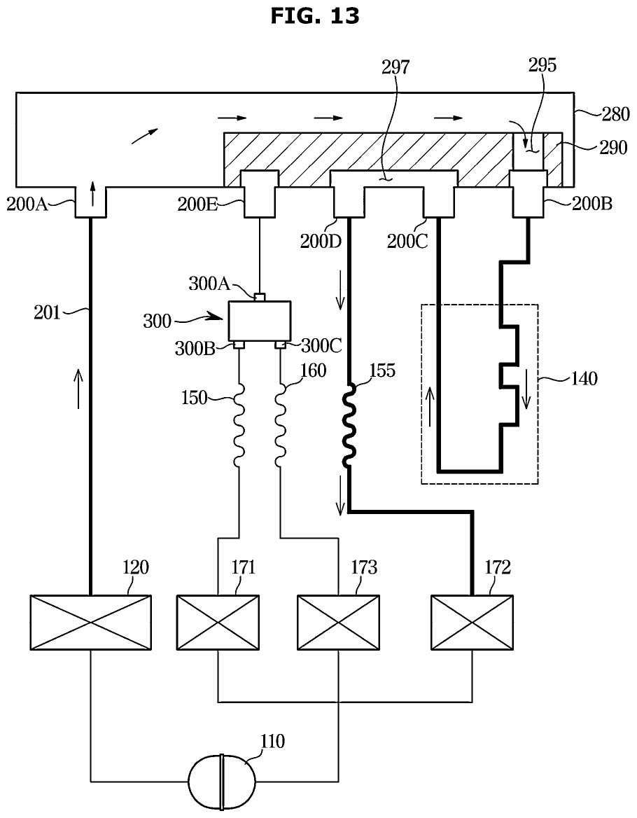

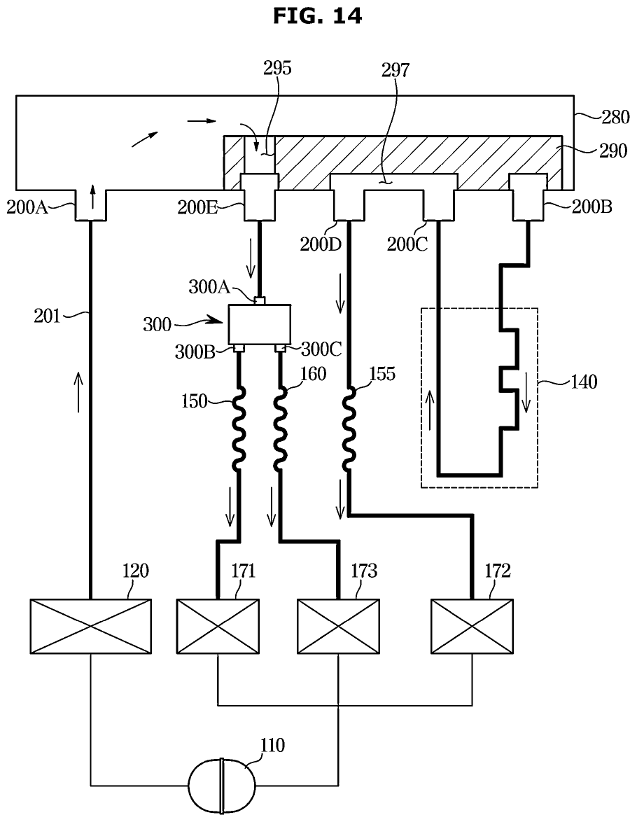

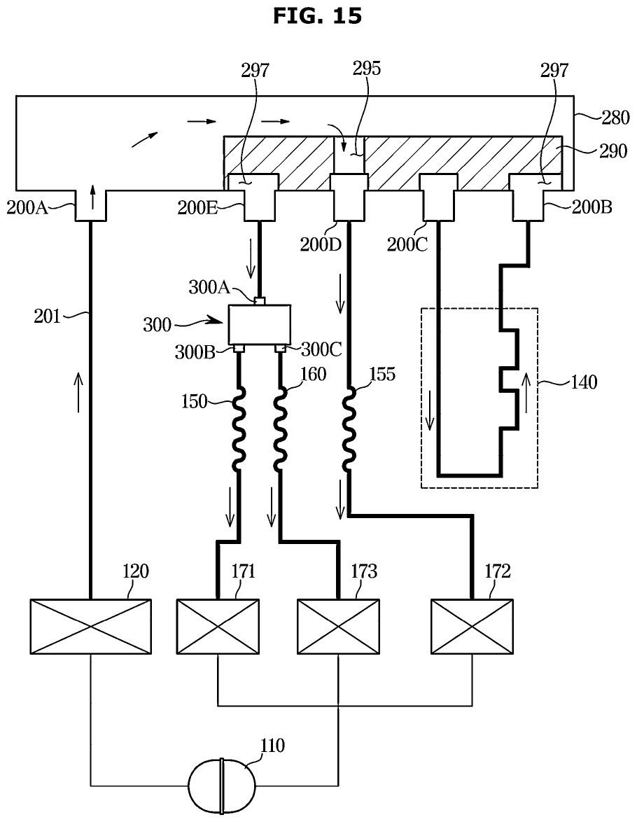

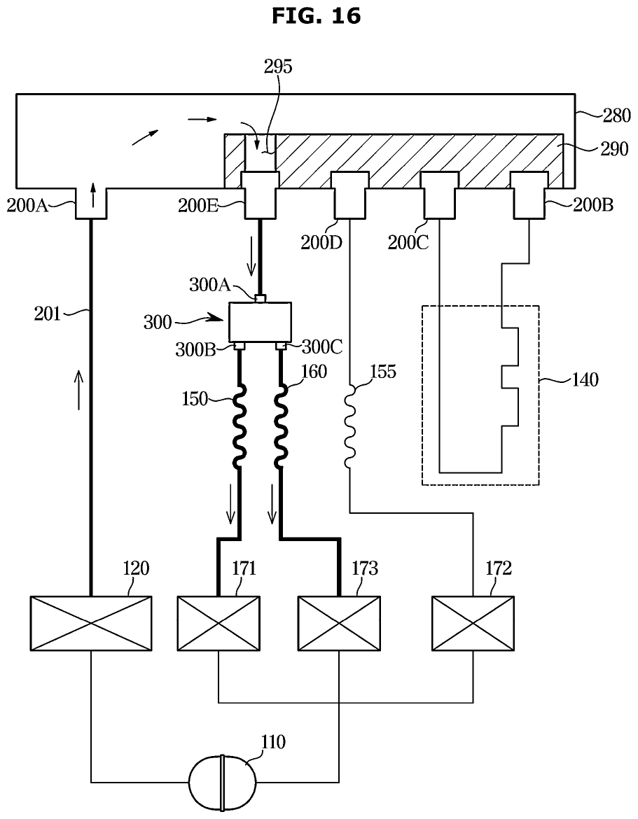

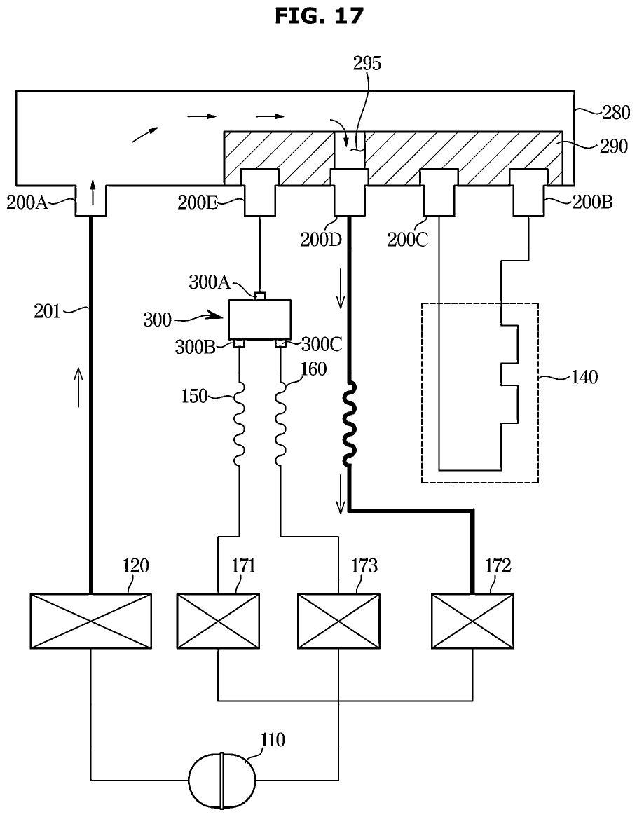

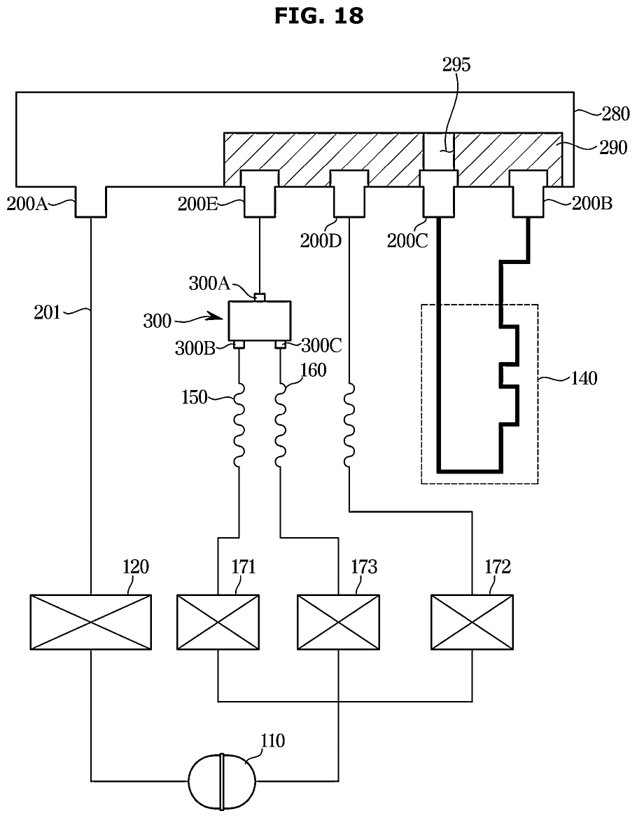

FIG. 12 illustrates a refrigerant flow through a valve device operating in a first mode in a case where a refrigerator operates in a first cooling mode and/or a second cooling mode according to an embodiment. FIG. 13 illustrates a refrigerant flow through a valve device operating in a first mode in a case where a refrigerator operates in a third cooling mode according to an embodiment. FIG. 14 illustrates a refrigerant flow through a valve device operating in a second mode in a case where a refrigerator operates in a first cooling mode and/or a second cooling mode according to an embodiment. FIG. 15 illustrates a refrigerant flow through a valve device operating in a second mode in a case where a refrigerator operates in a third cooling mode according to an embodiment. FIG. 16 illustrates a refrigerant flow through a valve device operating in a third mode in a case where a refrigerator operates in a first cooling mode and/or a second cooling mode according to an embodiment. FIG. 17 illustrates a refrigerant flow through a valve device operating in a third mode in a case where a refrigerator operates in a third cooling mode according to an embodiment. FIG. 18 illustrates a refrigerant flow through a valve device operating in a fourth mode.

The controller 60 may operate the first valve 200 in the first mode, the second mode, or the third mode during an operation of the compressor.

In addition, the controller 60 may operate the first valve 200 in the fourth mode in a state where the compressor is turned off.

In addition, the controller 60 may control the second valve 300 based on a cooling mode of the refrigerator 1.

In an embodiment, in the first mode, the controller 60 may control the first valve 200 to allow one of the first port 200B and the second port 200C to communicate with the first input port 200A and the other to communicate with the third port 200D or the fourth port 200E.

Hereinafter, in describing a refrigerant flow, the arrangement of each of the first evaporator 171, the second evaporator 172, and the third evaporator 173 may be changed. That is, although it is shown that the first capillary tube 150 and the first evaporator 171 are connected, the second capillary tube 155 and the second evaporator 172 are connected, and the third capillary tube 160 and the third evaporator 173 are connected, the connection relationships between the components are not limited thereto. For example, the second evaporator 172 may be connected to the third capillary tube 160.

Referring to FIG. 12, in a case where the refrigerator 1 operates in the first cooling mode or the second cooling mode, the controller 60 may control the first valve 200 to allow the first input port 200A to communicate with the second port 200C and the first port 200B to communicate with the fourth port 200E.

In this instance, the first cooling mode corresponds to a mode in which the refrigerant is supplied to the first evaporator 171, and the second cooling mode corresponds to a mode in which the refrigerant is supplied to the third evaporator 173.

Because the first input port 200A communicates with the second port 200C, the refrigerant discharged from the condenser 120 may be supplied to the hot pipe 140 through the open cavity 295, the refrigerant passing through the hot pipe 140 may be supplied to the fourth port 200E through the communication cavity 297, and the refrigerant supplied to the fourth port 200E may be supplied to the second input port 300A.

In a case where the refrigerator 1 operates in the first cooling mode, the controller 60 may control the second valve 300 to open the first output port 300B and close the second output port 300C.

In a case where the refrigerator 1 operates in the second cooling mode, the controller 60 may control the second valve 300 to close the first output port 300B and open the second output port 300C.

In a case where the refrigerator 1 operates in the simultaneous cooling mode, the controller 60 may control the second valve 300 to open both the first output port 300B and the second output port 300C.

According to the above refrigerant flow, the refrigerant passing through the hot pipe 140 may be supplied to the first evaporator 171 and/or the third evaporator 173.

Referring to FIG. 13, in a case where the refrigerator 1 operates in the third cooling mode, the controller 60 may control the first valve 200 to allow the first input port 200A to communicate with the first port 200B and the second port 200C to communicate with the third port 200D.

In this instance, the third cooling mode may refer to a mode in which the refrigerant is supplied to the second evaporator 172.

Because the first input port 200A communicates with the first port 200B, the refrigerant discharged from the condenser 120 may be supplied to the hot pipe 140 through the open cavity 295, the refrigerant passing through the hot pipe 140 may be supplied to the third port 200D through the communication cavity 297, and the refrigerant supplied to the third port 200D may be supplied to the second evaporator 172.

In a case where the refrigerator 1 operates in the third cooling mode, the controller 60 may control the second valve 300 to close the first output port 300B and the second output port 300C.

According to the above refrigerant flow, the refrigerant passing through the hot pipe 140 may be supplied to the second evaporator 172.

In an embodiment, in the second mode, the controller 60 may control the first valve 200 to close one of the first port 200B and the second port 200C and to allow the other to communicate with the third port 200D or the fourth port 200E.

Referring to FIG. 14, in a case where the refrigerator 1 operates in the first cooling mode or the second cooling mode, the controller 60 may control the first valve 200 to allow the first input port 200A to communicate with the fourth port 200E, to close the first port 200B, and to allow the second port 200C to communicate with the third port 200D.

In this instance, the first cooling mode corresponds to a mode in which the refrigerant is supplied to the first evaporator 171, and the second cooling mode corresponds to a mode in which the refrigerant is supplied to the third evaporator 173.

Because the first input port 200A communicates with the fourth port 200E, the refrigerant discharged from the condenser 120 may be supplied to the second input port 300A through the open cavity 295.

In addition, because the second port 200C communicates with the third port 200D in a state where the first port 200B is closed, the refrigerant left in the hot pipe 140 may be collected to the second evaporator 172 side through the communication cavity 297.

According to the second mode, the refrigerant left in the hot pipe 140 may be collected to the evaporator side.

In a case where the refrigerator 1 operates in the first cooling mode, the controller 60 may control the second valve 300 to open the first output port 300B and close the second output port 300C.

In a case where the refrigerator 1 operates in the second cooling mode, the controller 60 may control the second valve 300 to close the first output port 300B and open the second output port 300C.

In a case where the refrigerator 1 operates in the simultaneous cooling mode, the controller 60 may control the second valve 300 to open both the first output port 300B and the second output port 300C.

According to the above refrigerant flow, the refrigerant discharged from the condenser 120 may be supplied to the first evaporator 171 and/or the third evaporator 173 without passing through the hot pipe 140, and at the same time, the refrigerant left in the hot pipe 140 may be collected to the other evaporator 172.

Referring to FIG. 15, in a case where the refrigerator 1 operates in the third cooling mode, the controller 60 may control the first valve 200 to allow the first input port 200A to communicate with the third port 200D, to close the second port 200C, and to allow the first port 200B to communicate with the fourth port 200E.

In this instance, the third cooling mode may refer to a mode in which the refrigerant is supplied to the second evaporator 172.

Because the first input port 200A communicates with the third port 200D, the refrigerant discharged from the condenser 120 may be supplied to the second evaporator 172 through the open cavity 295.

In addition, because the first port 200B communicates with the fourth port 200E in a state where the second port 200C is closed, the refrigerant left in the hot pipe 140 may be collected to the evaporators 171 and 173 side through the communication cavity 297.

According to the second mode, the refrigerant left in the hot pipe 140 may be collected to the evaporator side.

In a case where the refrigerator 1 operates in the third cooling mode, the controller 60 may control the second valve 300 to open both the first output port 300B and the second output port 300C. Accordingly, the refrigerant may be quickly collected to the evaporators 171 and 173.

According to various embodiments, in a case where the first evaporator 171 and the second evaporator 172 are connected, the controller 60 may also control the second valve 300 to open the first output port 300B and close the second output port 300C.

According to various embodiments, in a case where the third evaporator 173 and the second evaporator 172 are connected, the controller 60 may also control the second valve 300 to open the second output port 300C and close the first output port 300B.

According to the above refrigerant flow, the refrigerant discharged from the condenser 120 may be supplied to the third evaporator 173 without passing through the hot pipe 140, and at the same time, the refrigerant left in the hot pipe 140 may be collected to the other evaporators 171 and 172.

In an embodiment, in the third mode, the controller 60 may control the first valve 200 to close the first port 200B and the second port 200C and to allow the first input port 200A to communicate with the third port 200D or the fourth port 200E.

Referring to FIG. 16, in a case where the refrigerator 1 operates in the first cooling mode or the second cooling mode, the controller 60 may control the first valve 200 to allow the first input port 200A to communicate with the fourth port 200E and to close the third port 200D.

In this instance, the first cooling mode may refer to a mode in which the refrigerant is supplied to the first evaporator 171, and the second cooling mode may refer to a mode in which the refrigerant is supplied to the third evaporator 173.

Because the first input port 200A communicates with the fourth port 200E, the refrigerant discharged from the condenser 120 may be supplied to the second valve 300 through the open cavity 295.

According to the third mode, the refrigerant discharged from the condenser 120 may be supplied to the evaporators 171, 172, and 173 without passing through the hot pipe 140.

In a case where the refrigerator 1 operates in the first cooling mode, the controller 60 may control the second valve 300 to open the first output port 300B and close the second output port 300C. Accordingly, the refrigerant may be supplied to the first evaporator 171 side.

In a case where the refrigerator 1 operates in the second cooling mode, the controller 60 may control the second valve 300 to close the first output port 300B and open the second output port 300C. Accordingly, the refrigerant may be supplied to the third evaporator 173 side.

Referring to FIG. 17, in a case where the refrigerator 1 operates in the third cooling mode, the controller 60 may control the first valve 200 to allow the first input port 200A to communicate with the third port 200D and to close the fourth port 200E.

In this instance, the third cooling mode may refer to a mode in which the refrigerant is supplied to the second evaporator 172.

Because the first input port 200A communicates with the third port 200D, the refrigerant discharged from the condenser 120 may be supplied to the second evaporator 172 through the open cavity 295.

According to the third mode, the refrigerant discharged from the condenser 120 may be supplied to the evaporators 171, 172, and 173 without passing through the hot pipe 140.

In a case where the refrigerator 1 operates in the third cooling mode, the controller 60 may control the second valve 300 to close the first output port 300B and the second output port 300C. Accordingly, the leakage of refrigerant to the other evaporators 171 and 173 may be prevented.

In an embodiment, in the fourth mode, the controller 60 may control the first valve 200 to close the third port 200D and the fourth port 200E.

Because the third port 200D and the fourth port 200E are closed, the refrigerant may not flow to the evaporators 171, 172, and 173.

Meanwhile, according to various embodiments, in the fourth mode, the controller 60 may control the first valve 200 to allow the first port 200B or the second port 200C to communicate with the first input port 200A.

In the fourth mode, because one of the first port 200B or the second port 200C is closed and the other communicates with the first input port 200A, the refrigerant flow into the first valve 200 and/or the hot pipe 140 may be stopped due to the pressure difference between the pressure inside the hot pipe 140 and the pressure outside the hot pipe 140.

Accordingly, the fourth mode may also be defined as a differential pressure mode.

The movement of refrigerant disappears as the compressor 110 is turned off, but the refrigerant having been in the first valve 200 may flow into the hot pipe 140 through the first port 200B or the second port 200C.

According to the disclosure, dew formation around the door 21, 22, or 31 may be prevented by leaving the high-temperature refrigerant in the hot pipe 140 when the compressor 110 is turned off.

As described above, various operations of the valve device 400 including the first valve 200 and the second valve 300 have been described.

According to the disclosure, by using the first valve 200 and the second valve 300, various modes (e.g., hot pipe-pass mode, refrigerant collection mode, hot pipe-bypass mode) may be implemented even in a case where the cold air supplier 100 includes the plurality of evaporators 171, 172, and 173.

In addition, each valve 200 and 300 may operate independently, thereby reducing the risk of failure.

However, in a case where the valve device 400 includes the first valve 200 and the second valve 300, the refrigerant may be supplied to all of the first evaporator 171, the second evaporator 172, and the third evaporator 173 simultaneously.

Hereinafter, an embodiment of the valve device 400 including a different type of valve is described.

FIG. 19A and FIG. 19B illustrate examples in which a valve device according to an embodiment includes a first valve and a second valve according to another embodiment.

Referring to FIGS. 19A and 19B, the cold air suppliers 100D and 100E according to an embodiment may each include the valve device 400 including a first valve 350 and a second valve 360.

In addition, the cold air suppliers 100D and 100E according to an embodiment may each include the first capillary tube 150 connected to the first evaporator 171, the second capillary tube 155 connected to the second evaporator 172, and the third capillary tube 160 connected to the third evaporator 173.

Referring to FIG. 19A, according to various embodiments, one end of the first evaporator 171 may be connected to the first capillary tube 150, and the other end may be connected to the second evaporator 172. One end of the second evaporator 172 may be connected to the second capillary tube 155 and the first evaporator 171, and the other end may be connected to the compressor 110. One end of the third evaporator 173 may be connected to the third capillary tube 160, and the other end may be connected to the compressor 110.

Referring to FIG. 19B, according to various embodiments, one end of the first evaporator 171 may be connected to the first capillary tube 150, and the other end may be connected to the compressor 110. One end of the second evaporator 172 may be connected to the second capillary tube 155, and the other end may be connected to the compressor 110. One end of the third evaporator 173 may be connected to the third capillary tube 160, and the other end may be connected to the compressor 110.

However, the arrangement of the first evaporator 171, the second evaporator 172, and the third evaporator 173 may be changed in various ways as required.

The first valve 350 may be implemented as a 4-way valve having four ports.

The first valve 350 may include a port 350A connected to the outlet of the condenser 120, a port 350C connected to one end of the hot pipe 140, a port 350D connected to the other end of the hot pipe 140, and a port 350B connected to the second valve 360.

The structure of the first valve 350 may be the same as that of the first valve 200 described above with reference to FIG. 4 to FIG. 9, except that a single port 200E is omitted.

The pad 290 of the first valve 350 may include an open cavity 355 that selectively opens one of a plurality of ports 350B, 350C and 350D formed in the boss 280. The open cavity 355 may be formed in a lower portion of the pad 290.

The pad 290 of the first valve 350 may include an open cavity 355 that selectively opens one of a plurality of ports 350B, 350C and 350D formed in the boss 280. The open cavity 355 may be formed in a lower portion of the pad 290.

The open cavity 355 may have a size to selectively open one (350B, 350C or 350D) of the plurality of ports 350B, 350C and 350D in the first area 295a or the second area 295b. The open cavity 355 may have a size that is unable to open two of the plurality of ports 350B, 350C and 350D at a time.

The pad 290 of the first valve 350 may be rotated along with the pad gear 250 to selectively open one (350B, 350C or 350D) of the plurality of ports 350B, 350C and 350D formed in the boss 280.

The pad 290 of the first valve 350 may include a communication cavity 357 that selectively communicates two (350B, 350C, 350D) of the plurality of ports 350B, 350C and 350D formed in the boss 280. The communication cavity 357 may be formed in the lower portion of the pad 290. The communication cavity 357 may have the form of a groove sunken upward from the bottom surface of the pad 290. The communication cavity 357 may communicate two adjacent ports (350B and 350C, 350C and 350D, 350D and 350B) among the plurality of ports 350B, 350C and 350D.

The second valve 360 may be implemented as a 4-way valve having four ports.

The second valve 360 may include a port 360A connected to the first valve 350, a port 300B connected to the first capillary tube 150, a port 300C connected to the second capillary tube 155, and a port 300D connected to the third capillary tube 160.

The compressor 110, the condenser 120, the dryer 130, the hot pipe 140, the valve device 400, the plurality of capillary tubes 150, 155 and 160, and the plurality of evaporators 171, 172 and 173 described above may be connected through connection tubes, and thus a closed loop refrigerant circuit in which refrigerant circulates may be formed in the refrigerator 1.

As the compressor 110 operates, the refrigerant may circulate in the direction of the compressor 110, the condenser 120, and the evaporators 171, 172, and 173.

According to various embodiments, the cold air supplier 100 may further include additional components, and some components (e.g., the dryer 130) may be omitted.

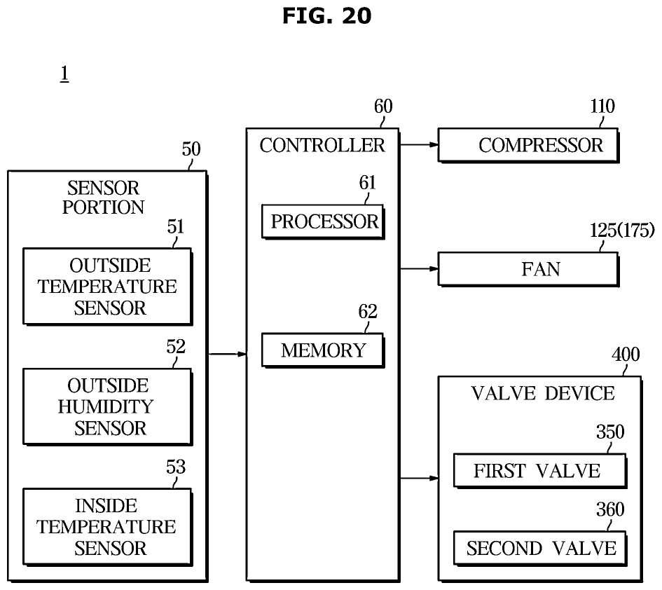

FIG. 20 is a block diagram illustrating a configuration of a refrigerator according to an embodiment.

Referring to FIG. 20, the refrigerator 1 according to an embodiment may include the sensor portion 50, the controller 60, and the cold air supplier 100.

Descriptions of components illustrated in FIG. 20 that overlap with those illustrated in FIG. 11 are omitted.

Referring to FIG. 20, the refrigerator 1 according to an embodiment may include the valve device 400 including the first valve 350 and the second valve 360.

The first valve 350 and the second valve 360 may be controlled independently of each other.

The controller 60 may independently control the first valve 350 and the second valve 360.

The controller 60 may control the compressor 110, the fans 125 and 175, and/or the valve device 400 based on information collected by the sensor portion 50 and setting information stored in the memory 62.

According to various embodiments, the controller 60 may operate the valve device 400 in the first mode, the second mode, or the third mode during an operation of the compressor 110.

In addition, the controller 60 may operate the valve device 400 in the fourth mode based on the compressor 110 being turned off.

As described above, the first to fourth modes are modes classified based on refrigerant flow, and a duplicate description thereof is omitted.

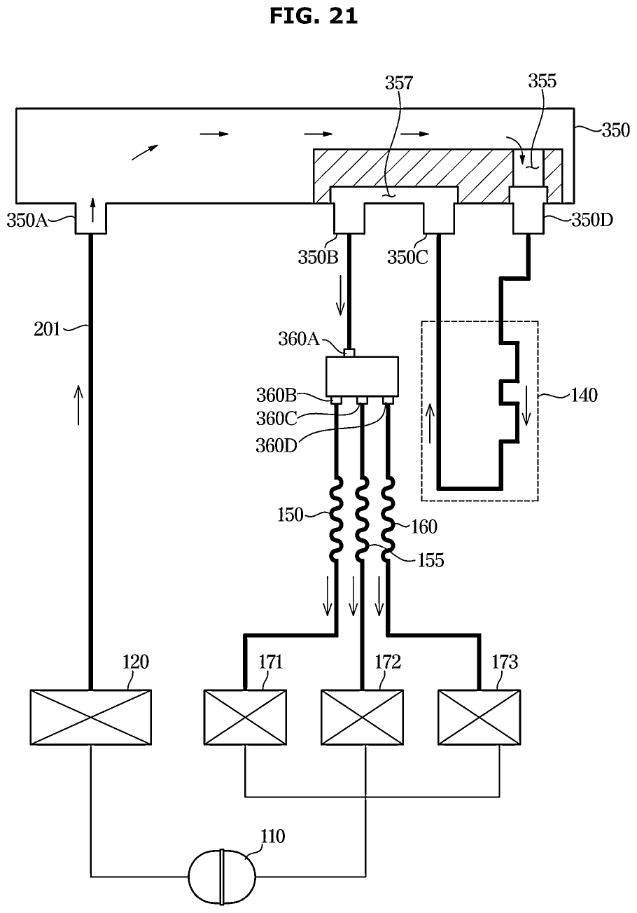

Hereinafter, the refrigerant flows according to an operation mode of the refrigerator and an operation mode of the valve device 400 are described with reference to FIG. 21 to FIG. 24.

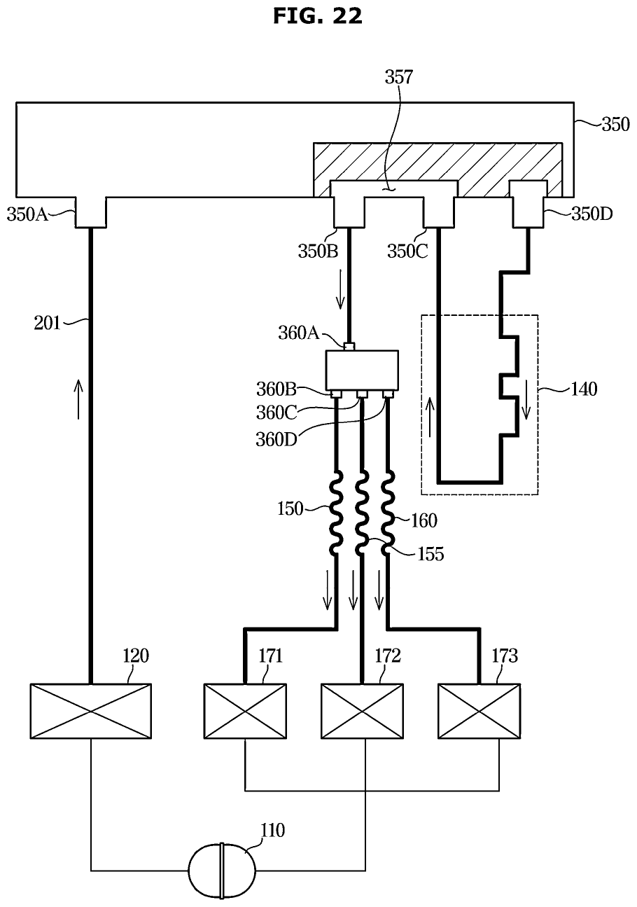

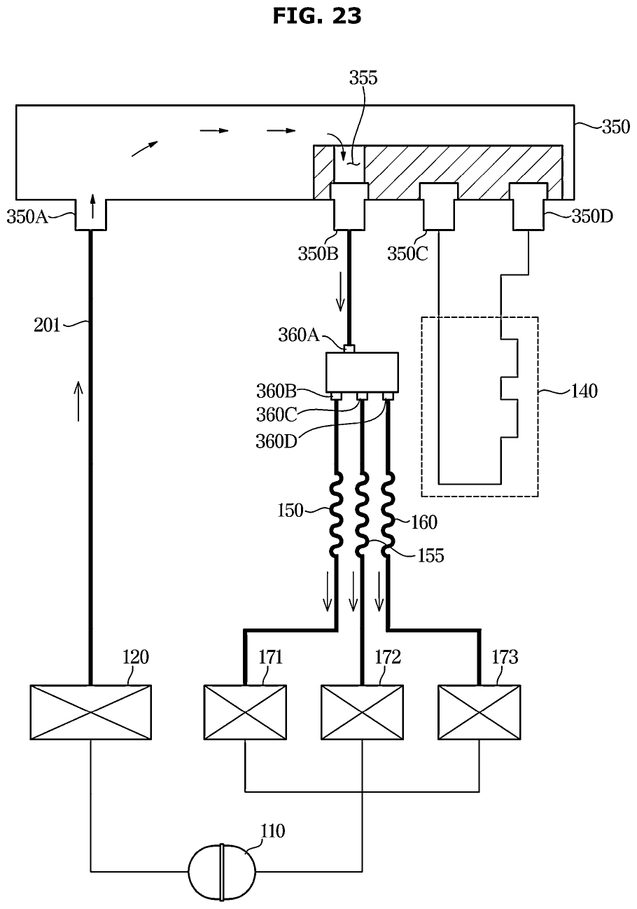

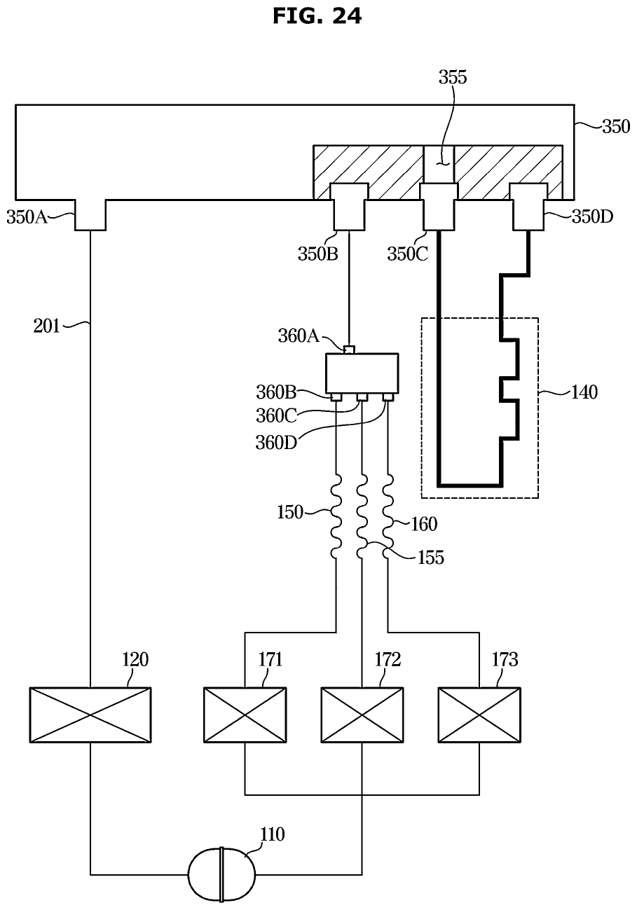

FIG. 21 illustrates a refrigerant flow through a valve device operating in a first mode. FIG. 22 illustrates a refrigerant flow through a valve device operating in a second mode. FIG. 23 illustrates a refrigerant flow through a valve device operating in a third mode. FIG. 24 illustrates a refrigerant flow through a valve device operating in a fourth mode.

Hereinafter, in describing a refrigerant flow, the arrangement of each of the first evaporator 171, the second evaporator 172, and the third evaporator 173 may be changed. That is, although it is shown that the first capillary tube 150 and the first evaporator 171 are connected, the second capillary tube 155 and the second evaporator 172 are connected, and the third capillary tube 160 and the third evaporator 173 are connected, connection relationships between the components are not limited thereto. For example, the second evaporator 172 may be connected to the third capillary tube 160.

Referring to FIG. 21, in an embodiment, in the first mode, the controller 60 may control the first valve 350 to allow the first input port 350A to communicate with the first port 350D and to allow the second port 350C to communicate with the third port 350B.

Because the first input port 350A communicates with the first port 350D, the refrigerant discharged from the condenser 120 may be supplied to the hot pipe 140 through the open cavity 355, the refrigerant passing through the hot pipe 140 may be supplied to the third port 350B through the communication cavity 357, and the refrigerant supplied to the third port 350B may be supplied to the second input port 360A of the second valve 360.

In a case where the refrigerator 1 operates in the first cooling mode, the controller 60 may control the second valve 360 to open the first output port 360B and close the second output port 360C and the third output port 360D.

In a case where the refrigerator 1 operates in the second cooling mode, the controller 60 may control the second valve 360 to open the second output port 360C and close the first output port 360B and the third output port 360D.

In a case where the refrigerator 1 operates in the third cooling mode, the controller 60 may control the second valve 360 to open the third output port 360C and close the second output port 360B and the first output port 360A.

In this instance, the first, second, and third cooling modes may refer to modes for supplying refrigerant to the first, second, and third evaporators 171, 172, and 173, respectively.

According to various embodiments, in a case where the refrigerator 1 operates in the fourth cooling mode, the controller 60 may control the second valve 360 to open the first output port 360B and the second output port 360C and close the third output port 360D.

In a case where the refrigerator 1 operates in the fifth cooling mode, the controller 60 may control the second valve 360 to open the second output port 360C and the third output port 360D and close the first output port 360B.

In a case where the refrigerator 1 operates in the sixth cooling mode, the controller 60 may control the second valve 360 to open the third output port 360C and the first output port 360B and close the second output port 360B.

In this instance, the fourth cooling mode may refer to a mode for supplying the refrigerant to each of the first evaporator 171 and the second evaporator 172, the fifth cooling mode may refer to a mode for supplying the refrigerant to each of the second evaporator 172 and third evaporator 173, and the sixth cooling mode may refer to a mode for supplying the refrigerant to each of the first evaporator 171 and third evaporator 173.

According to various embodiments, in a case where the refrigerator 1 operates in the simultaneous cooling mode, the controller 60 may control the second valve 360 to open all of the first output port 360B, the second output port 360C, and the third output port 360D.

According to the above refrigerant flow, the refrigerant passing through the hot pipe 140 may be supplied to the first evaporator 171 and/or the second evaporator 172 and/or the third evaporator 173.

Unlike the embodiment in which the valve device 400 includes the first valve 200 and the second valve 300, in the case where the valve device 400 includes the first valve 350 and the second valve 360, the refrigerant may be supplied to all of the evaporators 171, 172, and 173 simultaneously.

Accordingly, in the case where the valve device 400 includes the first valve 350 and the second valve 360, the refrigerator 1 may operate in more diverse cooling modes.

Referring to FIG. 22, in an embodiment, in the second mode, the controller 60 may control the first valve 350 to close the first port 350D and to allow the second port 350C to communicate with the third port 350B.

Because the second port 350C communicates with the third port 350B in a state where the first port 350D is closed, the refrigerant left in the hot pipe 140 may be collected to the evaporators 171, 172, and 173 through the communication cavity 357.

That is, according to the second mode, the refrigerant left in the hot pipe 140 may be collected to the evaporator side.

According to various embodiments, in the second mode, the controller 60 may control the second valve 360 to open at least one of the first output port 360B, the second output port 360C, or the third output port 360D.

For example, in the second mode, the controller 60 may control the second valve 360 to open all of the first output port 360B, the second output port 360C, and the third output port 360D.

According to the disclosure, a refrigerant recovery speed may be increased by opening all of the output ports 360B, 360C, and 360D.

Referring to FIG. 23, in an embodiment, in the third mode, the controller 60 may control the first valve 350 to close the first port 350D and the second port 350C and to allow the first input port 350A to communicate with the third port 350B.

According to the third mode, the refrigerant discharged from the condenser 120 may be directly supplied to the evaporators 171, 172, and 173.

According to various embodiments, in the third mode, the controller 60 may control the second valve 360 to open at least one of the first output port 360B, the second output port 360C, or the third output port 360D.

In a case where the refrigerator 1 operates in the first cooling mode, the controller 60 may control the second valve 360 to open the first output port 360B and close the second output port 360C and the third output port 360D.

In a case where the refrigerator 1 operates in the second cooling mode, the controller 60 may control the second valve 360 to open the second output port 360C and close the first output port 360B and the third output port 360D.

In a case where the refrigerator 1 operates in the third cooling mode, the controller 60 may control the second valve 360 to open the third output port 360D and close the second output port 360C and the first output port 360B.

In this instance, the first, second, and third cooling modes may refer to modes for supplying the refrigerant to the first, second, and third evaporators 171, 172, and 173, respectively.

According to various embodiments, in a case where the refrigerator 1 operates in the fourth cooling mode, the controller 60 may control the second valve 360 to open the first output port 360B and the second output port 360C and close the third output port 360D.

In a case where the refrigerator 1 operates in the fifth cooling mode, the controller 60 may control the second valve 360 to open the second output port 360C and the third output port 360D and close the first output port 360B.

In a case where the refrigerator 1 operates in the sixth cooling mode, the controller 60 may control the second valve 360 to open the third output port 360D and the first output port 360B and close the second output port 360C.

In this instance, the fourth cooling mode may refer to a mode in which the refrigerant is supplied to each of the first and second evaporators 171 and 172, the fifth cooling mode may refer to a mode in which the refrigerant is supplied to each of the second and third evaporators 172 and 173, and the sixth cooling mode may refer to a mode in which the refrigerant is supplied to each of the first and third evaporators 171 and 173.

According to various embodiments, in a case where the refrigerator 1 operates in the simultaneous cooling mode, the controller 60 may control the second valve 360 to open all of the first output port 360B, the second output port 360C, and the third output port 360D.

According to the above refrigerant flow, the refrigerant bypassing the hot pipe 140 may be supplied to the first evaporator 171 and/or the second evaporator 172 and/or the third evaporator 173.

Unlike the embodiment in which the valve device 400 includes the first valve 200 and the second valve 300, in the case where the valve device 400 includes the first valve 350 and the second valve 360, the refrigerant may be supplied to all of the evaporators 171, 172, and 173 simultaneously.

Accordingly, in the case where the valve device 400 includes the first valve 350 and the second valve 360, the refrigerator 1 may operate in more diverse cooling modes.

Referring to FIG. 24, in an embodiment, in the fourth mode, the controller 60 may control the first valve 350 to close the third port 350B.

As the third port 350B is closed, the refrigerant may not flow to the evaporators 171, 172, and 173. Meanwhile, according to various embodiments, in the fourth mode, the controller 60 may control the first valve 350 to allow the first port 350D or the second port 350C to communicate with the first input port 350A.

In the fourth mode, because one of the first port 350D or the second port 350C is closed and the other communicates with the first input port 350A, the refrigerant flow into the first valve 350 and/or the hot pipe 140 may be stopped due to the pressure difference between the pressure inside the hot pipe 140 and the pressure outside the hot pipe 140.

Accordingly, the fourth mode may also be defined as a differential pressure mode.

The movement of refrigerant disappears as the compressor 110 is turned off, but the refrigerant having been in the first valve 350 may flow into the hot pipe 140 through the first port 350D or the second port 350C.

According to the disclosure, dew formation around the door 21, 22, or 31 may be prevented by leaving the high-temperature refrigerant in the hot pipe 140 when the compressor 110 is turned off.

As described above, various operations of the valve device 400 including the first valve 350 and the second valve 360 have been described.

According to the disclosure, by using the first valve 350 and the second valve 360, various modes (e.g., hot pipe-pass mode, refrigerant collection mode, hot pipe-bypass mode) may be implemented even in a case where the cold air supplier 100 includes the plurality of evaporators 171, 172, and 173.

In addition, each valve 350 and 360 may operate independently, thereby reducing the risk of failure.

In addition, because the first valve 350 and the second valve 360 are implemented as 4-way valves with relatively low complexity, the risk of failure may be reduced.

In addition, because the second valve 360 is implemented as a general 4-way valve, the refrigerant may be simultaneously supplied to the first evaporator 171, the second evaporator 172, and the third evaporator 173.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be read only memory (ROM), random access memory (RAM), a magnetic tape, a magnetic disc, a flash memory, an optical data storage device, etc.

The computer-readable recording medium may be provided in the form of a non-transitory storage medium. The term ‘non-transitory storage medium’ may refer to a tangible device without including a signal, e.g., electromagnetic waves, and may not distinguish between storing data in the storage medium semi-permanently and temporarily. For example, the ‘non-transitory storage medium’ may include a buffer that temporarily stores data.

In an embodiment of the disclosure, the aforementioned method according to the one or more embodiments of the disclosure may be provided in a computer program product. The computer program product may be a commercial product that may be traded between a seller and a buyer. The computer program product may be distributed in the form of a storage medium (e.g., a compact disc read only memory (CD-ROM)), through an application store (e.g., Play Store™), directly between two user devices (e.g., smart phones), or online (e.g., downloaded or uploaded). In the case of online distribution, at least part of the computer program product (e.g., a downloadable app) may be at least temporarily stored or arbitrarily created in a storage medium that may be readable to a device such as a server of the manufacturer, a server of the application store, or a relay server.

Although the embodiments of the disclosure have been provided for illustrative purposes, the scope of the disclosure is limited to the embodiments of the disclosure. One or more embodiments that may be modified and altered by those skilled in the art without departing from the principles and spirit of the disclosure, the scope of which is defined in the claims, should be construed as falling within the scope of the disclosure.

What is claimed is:

1. A refrigerator, comprising:
a compressor;
a condenser connected to an outlet of the compressor;
a hot pipe;
a first capillary tube;
a second capillary tube;
a third capillary tube;
a first valve including:
a first input port connected to an outlet of the condenser;
a first port connected to one end of the hot pipe;
a second port connected to another end of the hot pipe; and
a third port;
a second valve including:
a second input port connected to the third port;
a first output port connected to the first capillary tube;
a second output port connected to the second capillary tube; and
a third output port connected to the third capillary tube; and
a controller configured to:
operate the first valve in a first mode, a second mode or a third mode during an operation of the compressor;
control the first valve to allow the first input port to communicate with the first port and to allow the second port to communicate with the third port in the first mode;
control the first valve to close the second port and to allow the first port to communicate with the third port in the second mode; and
control the first valve to close the first port and the second port and to allow the first input port to communicate with the third port in the third mode.

2. The refrigerator of claim 1, wherein the controller is configured to control the first valve to close the third port based on the compressor being turned off.

3. The refrigerator of claim 1, further comprising:
a first evaporator connected to the first capillary tube;
a second evaporator connected to the second capillary tube; and
a third evaporator connected to the third capillary tube.

4. The refrigerator of claim 1, wherein:
a refrigerant flowing into the first input port passes through the hot pipe, and is discharged to the second valve in the first mode,
a refrigerant left in the hot pipe is collected to the second valve in the second mode, and
a refrigerant flowing into the first input port bypasses the hot pipe, and is discharged to the second valve in the third mode.

5. The refrigerator of claim 1, wherein the controller is configured to control the second valve based on an operation mode of the refrigerator.

6. The refrigerator of claim 5, wherein the controller is configured to:
control the second valve to open the first output port based on the refrigerator being operating in a first cooling mode;
control the second valve to open the second output port based on the refrigerator being operating in a second cooling mode; and
control the second valve to open the third output port based on the refrigerator being operating in a third cooling mode.

7. The refrigerator of claim 5, wherein the controller is configured to control the second valve to open the first output port, the second output port and the third output port, based on the refrigerator being operating in a simultaneous cooling mode.

8. The refrigerator of claim 5, wherein the controller is configured to:
control the second valve to open the first output port and the second output port based on the refrigerator being operating in a fourth cooling mode;
control the second valve to open the first output port and the third output port based on the refrigerator being operating in a fifth cooling mode; and
control the second valve to open the second output port and the third output port based on the refrigerator being operating in a sixth cooling mode.

9. The refrigerator of claim 1, wherein the first valve and the second valve are configured to be controlled independently.

10. The refrigerator of claim 1, wherein the first valve comprises:
an open cavity configured to selectively open one of the first port, the second port, and the third port; and
a communication cavity configured to selectively communicate two ports among the first port, the second port, and the third port.

11. The refrigerator of claim 1, wherein the second valve is configured to selectively open the first output port, the second output port, and the third output port.

12. A method for controlling a refrigerator comprising a compressor, a condenser connected to an outlet of the compressor, a hot pipe, a first capillary tube, a second capillary tube, a third capillary tube, a first valve including a first input port connected to an outlet of the condenser, a first port connected to one end of the hot pipe, a second port connected to another end of the hot pipe, and a third port, and a second valve including a second input port connected to the third port, a first output port connected to the first capillary tube, a second output port connected to the second capillary tube, and a third output port connected to the third capillary tube, the method comprising:
operating the first valve in a first mode, a second mode or a third mode during an operation of the compressor;
controlling the first valve to allow the first input port to communicate with the second port and to allow the first port to communicate with the third port in the first mode;
controlling the first valve to close the second port and to allow the first port to communicate with the third port in the second mode; and
controlling the first valve to close the first port and the second port and to allow the first input port to communicate with the third port in the third mode.

13. A refrigerator comprising:
a compressor;
a condenser connected to an outlet of the compressor;
a hot pipe;
a first capillary tube;
a second capillary tube;
a third capillary tube;
a first valve including:
a first input port connected to an outlet of the condenser;
a first port connected to one end of the hot pipe;
a second port connected to another end of the hot pipe;
a third port connected to the third capillary tube; and
a fourth port;
a second valve including:
a second input port connected to the fourth port;
a first output port connected to the first capillary tube; and
a second output port connected to the second capillary tube; and
a controller configured to:
operate the first valve in a first mode, a second mode or a third mode during an operation of the compressor;
control the first valve to allow one of the first port and the second port to communicate with the first input port and the other to communicate with the third port or the fourth port in the first mode;
control the first valve to close one of the first port and the second port and to allow the other to communicate with the third port or the fourth port in the second mode; and
control the first valve to close the first port and the second port and to allow the first input port to communicate with the third port or the fourth port in the third mode.

14. The refrigerator of claim 13, wherein the controller is configured to control the first valve to close the fourth port based on the compressor being turned off.

15. The refrigerator of claim 13, further comprising:
a first evaporator connected to the first capillary tube;
a second evaporator connected to the second capillary tube; and
a third evaporator connected to the third capillary tube.

16. The refrigerator of claim 13, the first evaporator is connected to the third evaporator.

17. The refrigerator of claim 16, in the first mode, the controller is configured to:
based on the refrigerator being operating in a first cooling mode, control the first valve to allow the first input port to communicate with the second port and to allow the first port to communicate with the fourth port, and control the second valve to open the first output port;
based on the refrigerator being operating in a second cooling mode, control the first valve to allow the first input port to communicate with the second port and to allow the first port to communicate with the fourth port and control the second valve to open the second output port; and
based on the refrigerator being operating in a third cooling mode, control the first valve to allow the first input port to communicate with the first port and to allow the second port to communicate with the third port.

18. The refrigerator of claim 16, in the second mode, the controller is configured to:
based on the refrigerator being operating in a first cooling mode, control the first valve to allow the first input port to communicate with the fourth port, to close the second port, and to allow the first port to communicate with the third port, and control the second valve to open the first output port;
based on the refrigerator being operating in a second cooling mode, control the first valve to allow the first input port to communicate with the fourth port, to close the second port, and to allow the first port to communicate with the third port, and control the second valve to open the second output port; and
based on the refrigerator being operating in a third cooling mode, control the first valve to allow the first input port to communicate with the third port, to close the first port, and to allow the second port to communicate with the fourth port.

19. The refrigerator of claim 16, in the third mode, the controller is configured to:
based on the refrigerator being operating in a first cooling mode, control the first valve to allow the first input port to communicate with the fourth port and control the second valve to open the first output port;
based on the refrigerator being operating in a second cooling mode, control the first valve to allow the first input port to communicate with the fourth port and control the second valve to open the second output port; and
based on the refrigerator being operating in a third cooling mode, control the first valve to allow the first input port to communicate with the third port.

20. The refrigerator of claim 13, wherein the first valve includes:
an open cavity configured to selectively open one of the first port. the second port, the third port and the fourth port; and
a communication cavity configured to selectively communicate two ports among the first port, the second port, the third port and the fourth port.
